(19) United States
(12) Patent Application Publication
(10) Pub. No.: US 2008/0258049 A1
(43) Pub. Date: Oct. 23, 2008

(54) Quantum repeater using atomic cascade transitions

(76) Inventors: Alexander M. Kuzmich, Atlanta, GA (US); Dzmitry N. Matsukevich, Atlanta, GA (US); Thierry Chaneliere, Atlanta, GA (US); Stewart D. Jenkins, Dacula, GA (US); ThomasAlbert Brian Kennedy, Smyrna, GA (US); Michael S. Chapman, Dunwoody, GA (US)

Correspondence Address: Merchant & Gould LLC, P.O. Box 2903, Minneapolis, MN, 55402-0903, US

(21) Appl. No.: 11/787,876

(22) Filed: Apr. 18, 2007

(51) Int. Cl. G02F 1/01

(52) U.S. Cl. 250/214.1

(57) ABSTRACT

Via atomic cascade emission, an entangled pair of photons may be generated. A first one of the entangled pair may be ideal for long-distance communication. The other one may be suited for mapping to a long-lived atomic memory. Also, a deterministic single photon may be produced using a feedback system. If the feedback system indicates that an excitation exists in an atomic ensemble, then the atomic ensemble may be hit with a laser to produce the deterministic single photon. Furthermore, gas in the atomic ensemble may be subdivided into independent elements each of which may function as a memory element itself. In addition, dual species matter qubits may be entangled with light. A volume in an atomic ensemble may comprise a first isotope vapor storing a first state of a qubit. The volume may also comprise a second isotope vapor configured to store a second state of the qubit.

### BACKGROUND

A qubit is a quantum bit, the counterpart in quantum computing to the binary digit or bit of classical computing. Just as a bit is the basic unit of information in a classical computer or communications system, a qubit is the basic unit of information in a quantum computer or quantum communications system.

A qubit may be an electron in a magnetic field. The electron's spin may be either in alignment with the field, which is known as a spin-up state, or opposite to the field, which is known as a spin-down state. Changing the electron's spin from one state to another is achieved by using a pulse of energy, such as from a laser using one unit of laser energy. If half a unit of laser energy used and the particle is completely isolate from all external influences, according to quantum law, the particle then enters a superposition of states, in which it behaves as if it were in both states simultaneously. Each qubit utilized could take a superposition of both 0 and 1. Thus, the number of computations that a quantum computer could undertake is 2̂n, where n is the number of qubits used.

Moreover, these particles interact with each other via quantum entanglement. Particles that have interacted at some point retain a type of connection and can be entangled with each other in pairs, in a process known as correlation. Knowing the spin state of one entangled particle (e.g. up or down) allows one to know that the spin of its mate is in the opposite direction. Furthermore, due to the phenomenon of superposition, the measured particle has no single spin direction before being measured, but is simultaneously in both a spin-up and spin-down state. The spin state of the particle being measured is decided at the time of measurement and communicated to the correlated particle, which simultaneously assumes the opposite spin direction to that of the measured particle. Quantum entanglement allows qubits that are separated by incredible distances to interact with each other instantaneously (not limited to the speed of light). No matter how great the distance between the correlated particles, they will remain entangled as long as they are isolated.

### SUMMARY OF THE INVENTION

Consistent with embodiments of the present invention, systems and methods are disclosed for a quantum communications using a repeater. Via atomic cascade emission, an entangled pair of photons may be generated. A first one of the entangled pair may be ideal for long-distance communication. The other one may be suited for mapping to a long-lived atomic memory. Also, a deterministic single photon may be produced using a feedback system. If the feedback system indicates that an excitation exists in an atomic ensemble, then the atomic ensemble may be hit with a laser to produce the deterministic single photon. Furthermore, gas in the atomic ensemble may be subdivided into independent elements each of which may function as a memory element itself. In addition, dual species matter qubits may be entangled with light. A volume in an atomic ensemble may comprise a first isotope vapor storing a first state of a qubit. The volume may also comprise a second isotope vapor configured to store a second state of the qubit.

It is to be understood that both the foregoing general description and the following detailed description are examples and explanatory only, and should not be considered to restrict the invention's scope, as described and claimed. Further, features and/or variations may be provided in addition to those set forth herein. For example, embodiments of the invention may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a quantum communications system;

FIG. 2 is a flow chart of a method for quantum communications using a repeater;

FIG. 3A is a diagram showing an atomic structure for a cascade emission scheme;

FIG. 3B is a diagram showing a setup based on ultracold 85Rb atomic gas;

FIG. 4A is a diagram showing results of a stationary signal-idler intensity correlation function;

FIG. 4B is a diagram showing results of a stationary signal-idler intensity correlation function;

FIG. 4C is a diagram showing results of a stationary signal-idler intensity correlation function;

FIG. 4D is a diagram showing results of a stationary signal-idler intensity correlation function;

FIG. 5A is a diagram showing results of a stationary signal-idler intensity correlation function;

FIG. 5B is a diagram showing results of a stationary signal-idler intensity correlation function;

FIG. 6 is a diagram showing efficiency of storage and subsequent retrieval of a coherent idler field;

FIG. 7 is a diagram showing a single-photon generation system;

FIG. 8A is a diagram showing the results of a characterization of an improved source of heralded single photons;

FIG. 8B is a diagram showing the results of a characterization of an improved source of heralded single photons;

FIG. 9A is a diagram showing the measured degree of 2nd order coherence for zero time delay;

FIG. 9B is a diagram showing the measured degree of 2nd order coherence for zero time delay;

FIG. 9C is a diagram showing the measured degree of 2nd order coherence for zero time delay;

FIG. 9D is a diagram showing the measured degree of 2nd order coherence for zero time delay;

FIG. 10A is a diagram showing a quantum repeater;

FIG. 10B is a diagram showing a quantum repeater;

FIG. 10C is a diagram showing a quantum repeater;

FIG. 11 is a diagram showing the characteristically sharp increase in (T)_{T} for small T;

FIG. 12 is a diagram showing a comparison of the entanglement connection rates;

FIG. 13 is a diagram showing the fractional entanglement connection rate;

FIG. 14 is a diagram showing the entanglement distribution rate;

FIG. 15A is a diagram showing two qubit states that may be encoded in spatially separated systems;

FIG. 15B is a diagram showing an architecture to encode two qubit states into two distinct matter species;

FIG. 16 is a diagram showing a schematic showing the geometry of the addressing and scattered fields from the co-trapped isotope mixture; and

FIG. 17 is a diagram showing measured Cₛᵢ(φₛ,φᵢ) as a function of φᵢ.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

### Quantum Telecommunication Based on Atomic Cascade Transitions

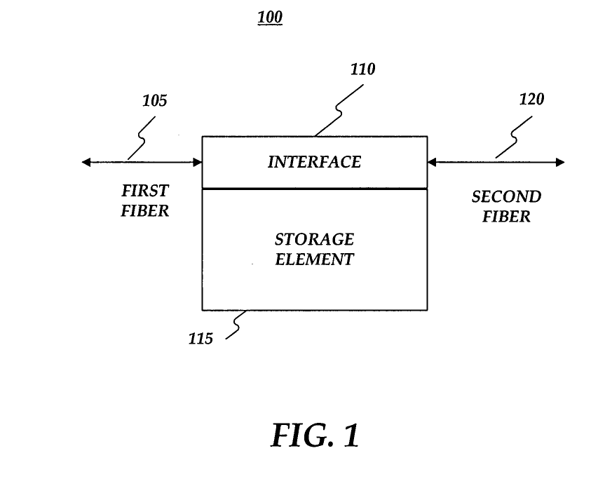

Quantum communications using a repeater may be provided. Consistent with embodiments of the present invention, FIG. 1 is a block diagram of a quantum communications system. System 100 includes a first fiber 105, an interface 110, a storage element 115, and a second fiber 120. Storage element 115 may comprise an atomic ensemble or even a single atom. Data in the form of a signal may be transmitted through first fiber 105 and received at interface 110. Interface 110 may cause the data from the signal to be stored in storage element 115 (e.g. an atomic ensemble or a single atom.) Furthermore, interface 110 may retrieve the data stored in storage element 115, create a second signal corresponding to the retrieved data, and transmit the second signal through second fiber 120. Another interface and storage element combination similar to interface 110 and storage element 115 may receive the second signal from second fiber 120 and repeat the aforementioned process. In this way, the data may be transmitted and repeated over long distances using, for example, the laws of quantum mechanics.

Consistent with embodiments of the inventions, in order to efficiently transmit and store data corresponding to the signals (e.g. the first signal or the second signal), the signals may be transmitted through the fibers within a certain frequency range (e.g. the telecommunication wavelength window.) In this way the frequency may be chosen that minimizes dissipation of the signal in the fiber. Consistent with embodiments of the invention, a quantum repeater (e.g. interface 110) at telecommunications wavelengths with long-lived atomic memory (e.g. storage element 115) may be provided. Via atomic cascade emission, for example, an entangled pair of photons may be generated. A first one of the entangled pair may be ideal for long-distance quantum communication (e.g. in the telecommunication wavelength window.) The other one of the entangled pair of photons may be suited for mapping to a long-lived atomic memory (e.g. storage element 115.) Together with photonic-to-atomic qubit conversion, elements for a telecommunications quantum repeater may be provided.

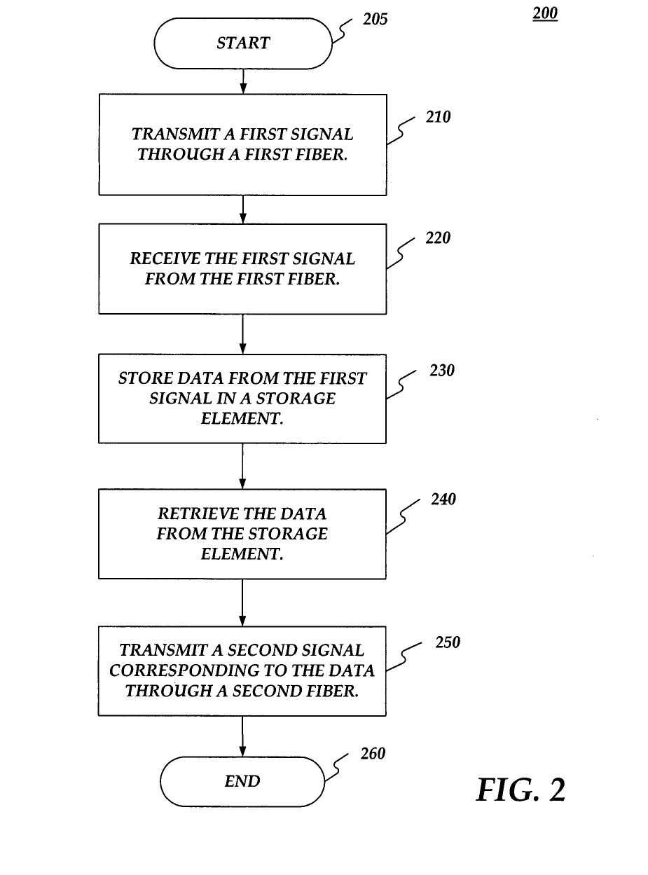

FIG. 2 is a flow chart setting forth the general stages involved in a method 200 consistent with an embodiment of the invention for providing quantum communications using a repeater. Method 200 may be implemented using communications system 100 as described in more detail below with respect to FIG. 2. Ways to implement the stages of method 200 will be described in greater detail below. Method 200 may begin at starting block 205 and proceed to stage 210 where communications system 100 may transmit a first signal through first fiber 105. For example, the first signal may be transmitted within a particular wavelength range (e.g. the telecommunication wavelength window.) In this way the frequency may be chosen that minimizes dissipation of the signal in first fiber 105.

From stage 210, where communications system 100 transmits the first signal through first fiber 105, method 200 may advance to stage 220 where communications system 100 may receive the first signal from first fiber 105. For example, interface 110 may cause the data from the first signal to be removed from first fiber 105. Once communications system 100 receives the first signal from first fiber 105 in stage 220, method 200 may continue to stage 230 where communications system 100 may store data from the first signal in storage element 115. For example, data from the first signal may be stored in storage element 115 comprising an atomic ensemble as described below.

After communications system 100 stores data from the first signal in storage element 115 in stage 230, method 200 may proceed to stage 240 where communications system 100 may retrieve the data from storage element 115. For example, data may be retrieved from storage element 115 comprising an atomic ensemble as described below. Once communications system 100 retrieves the data from storage element 115 in stage 240, method 200 may continue to stage 250 where communications system 100 may transmit a second signal corresponding to the data through second fiber 120. For example, the second signal may be transmitted within a particular wavelength range (e.g. the telecommunication wavelength window.) In this way the frequency may be chosen that minimizes dissipation of the signal in second fiber 120. Once communications system 100 transmits the second signal corresponding to the data through second fiber 120 in stage 250, method 200 may then end at stage 260.

Consistent with embodiments of the invention, a telecommunications wavelength quantum repeater based on cascade atomic transitions in either (1) a single atom or (2) an atomic ensemble. The latter case will first be described, with particular reference to alkali metals. Such ensembles, with long-lived ground level coherences may be prepared in either a solid or a gas phase, for example, a cold atomic vapor confined in high vacuum. The cascade transitions may be chosen so that a first photon (signal) emitted on an upper arm (described below) has telecommunication range wavelength, while a second photon (idler), emitted to an atomic ground state (described below), is naturally suited for mapping into atomic memory. Embodiments of the invention may include phase-matched cascade emission in an ensemble of cold rubidium atoms using two different cascades: (a) at the signal wavelength λₛ=776 nm, via the 5_{s1/2}→5_{d5/2} two-photon excitation; (b) at λₛ=1.53 μm, via the 5_{s1/2}→4_{d5/2} two-photon excitation. Embodiments of the invention may include polarization entanglement of the emitted photon pairs and superradiant temporal profiles of the idler field in both cases.

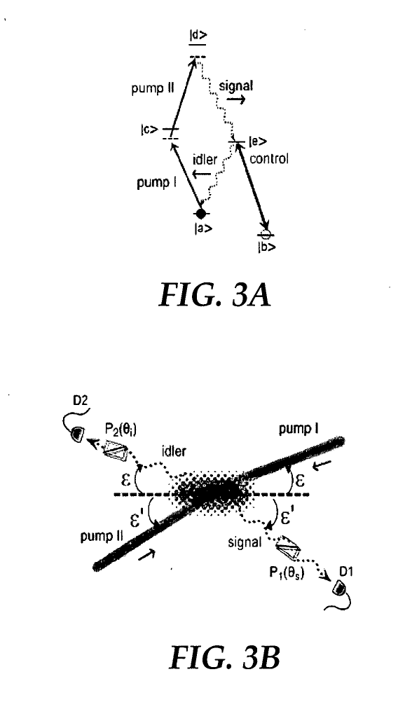

As shown in FIG. 3A, in a first stage, an atomic sample may be used. As shown in FIG. 3A, the atomic sample may be prepared in level |a , (e.g., by means of optical pumping.) For an atomic ensemble qubit, an incoherent mixture of Zeeman states may be sufficient. The upper level |d , which may be of either s or d type, may be excited either by one- or two-photon transitions, the latter through an intermediate level |c>. An advantage of two-photon excitation may be that it may allow for noncollinear phase matching of signal and idler photons; single-photon excitation may be forbidden in electric dipole approximation and phase-matched emission is restricted to a collinear geometry (this argument implicitly assumes that the refractive index of the vapor is approximately unity). For example, the excitation may be two-photon detuned from the upper level |d , creating a virtual excitation.

As shown in FIG. 3, the atomic structure for the cascade emission scheme, consistent with embodiments of the invention, may involve excitation by pumps I and II. Pump II and the signal photons may lie in the telecommunication wavelength range when a suitable level of orbital angular momentum L=0 or L=2 is used as level |d>. For atomic rubidium, the signal wavelength may be 1.32 μm (6s_{1/2}→5p_{1/2} transition), 1.37 μm (6s_{1/2}→5p_{3/2} transition), 1.48 μm (4d_{3/2(5/2)}→5p_{1/2} transition), 1.53 μm (4d_{3/2(5/2)}→5p_{3/2} transition). For atomic cesium, the signal wavelength may be 1.36 μm (7s_{1/2}→6p_{1/2} transition), 1.47 μm (7s_{1/2}→6p_{3/2} transition). For Na and K the corresponding wavelengths may be in the 1.1-1.4 μm range. FIG. 3B shows a setup based on ultracold ⁸⁵Rb atomic gas. For λₛ=776 nm, phase matching may result in the angles ε′≈ε≈1°, while for λₛ=1.53 μm, ε′≈2ε≈2°. P₁ and P₂ are polarizers; D1 and D2 are detectors.

In a second stage, scattering may be performed via the upper level |d to ground level |a through the intermediate level |e (where |e may coincide with |c results in the cascaded emission of signal and idler fields. The signal field, which is emitted on the upper arm, may have a temporal profile identical to that of the laser excitation as a consequence of the large two-photon detuning. As noted above, the wavelength of this field may lie in the 1.1-1.6 μm range, depending on the alkali-metal transition used. The signal field can be coupled to an optical fiber (e.g. first fiber 105 or second fiber 120) that may have losses as low as 0.2 dB/km and transmitted to a remote location.

The temporal profile of the idler field can be much shorter than the single-atom spontaneous decay time tₛ of the intermediate level. Under the conditions of a large Fresnel number of the exciting laser fields, the decay time may be of order tₛ/dₜₕ, characteristic of superradiance. Here dₜₕ≈3nλ²l/(8^{π}) may be the optical thickness, where λ may be the wavelength, n may be the number density, and l may be the length of the sample.

The direction of the idler field may be determined by the phase matching condition k₁+k₂=kₛ+kᵢ where k₁ and k₂ are the wave vectors of the laser fields I and II, respectively. Under conditions of phase matching, collective enhancement may cause emission of the idler photon correlated with a return of the atom into the Zeeman state from which it originated. The fact that the atom begins and ends the absorption-emission cycle in the same state may be essential for strong signal-idler polarization correlations. The reduced density operator for the field, taking into account collective enhancement, may be derived by:

\hat{ρ}(t)≈[1+\sqrt{ε}Â₂^{†}(t)]\hat{ρ}_{vac}[1+\sqrt{ε}Â₂(t)], (1)

where p_{vac} is the vacuum state of the field, Â₂^{†}(t) is a time-dependent two-photon creation operator for the signal and idler fields, and ε<<I. For linearly polarized pumps with parallel (vertical) polarizations, the long-time limit may be found in:

Â₂^{†}(t)=(cos χ)â_{H}^{†}\hat{b}_{H}^{†}+(sin χ)â_{V}^{†}\hat{b}_{V}^{†}, (2)

where x is determined Clebsch-Gordan coupling coefficients, â_{H(V)}^{†} and \hat{b}_{H(V)}^{†} may be creation operators for a horizontally (vertically) polarized signal and idler photon, respectively. For the hyperfine level configuration Fₐ=3→F_{c}=4=F_{e→}F_{d}=5, and for an unpolarized atomic sample, we find sin χ=2 cos χ=2/^{\sqrt{5}}.

Next, in a third stage, the photonic qubit may be encoded in the idler field polarization. Photonic-to-atomic qubit conversion may be achieved. Such conversion can be performed either within the same ensemble or in a suitably prepared adjacent ensemble or pair of ensembles. In either case, a strong laser control beam may be used to couple the other ground hyperfine level /b to the intermediate level /e . Collective excitations involving two orthogonal hyperfine coherences serve as the logical states of the atomic qubit.

Embodiments of the invention may provide phase-matched cascade emission of entangled photon pairs, using samples of cold ⁸⁵Rb atoms, for two different atomic cascades: (a) at λₛ=776 nm, via the 5s_{1/2}→5d_{5/2} two-photon excitation; (b) at λₛ=1.53 μm, via the 5s_{1/2}→4d_{5/2} two-photon excitation. A magneto-optical trap (MOT) of ⁸⁵Rb may provide an optically thick cold atomic cloud. The atoms may be prepared in an incoherent mixture of the level /a , which corresponds to the 5s_{1/2}, Fₐ=3 ground level, by means of optical pumping. The intermediate level /c =/e may correspond to the 5p_{3/2}, F_{c}=4 level of the D₂ line at 780 nm, and the excited level /d represents (a) the 5d_{5/2} level with λₛ=776 nm, or (b) the 4d₅/₂ level with λₛ=1.53 μm. Atomic level /b may correspond to 5s_{1/2}, F_{b}=2, and could be used to implement the light-to-matter qubit conversion.

The trapping and cooling light as well as the quadrupole magnetic field of the MOT are switched off for the 2 ms duration of the measurement. The ambient magnetic field is compensated by three pairs of Helmholtz coils. Counter-propagating pumps I (e.g. at 780 nm) and II (e.g. at 776 nm or 1.53 μm), tuned to two-photon resonance for the /a →/d transition may be focused into the MOT using the off-axis, counterpropagating geometry of Harris and co-workers. This two-photon excitation may induce phase-matched signal and idler emission.

With quasi-cw pump fields, photoelectric coincidence detection of the signal and idler fields may be perform. The latter may be directed onto single-photon detectors D1 and D2. For λₛ=1.53 μm, the signal field may be coupled into 100 m of single-mode fiber, and detector D1 (cooled (In,Ga) as photon counting module) may be gated using the output pulse of silicon detector D2. The delay between the electronic pulses from D1 and D2 may be determined with 1 ns time resolution.

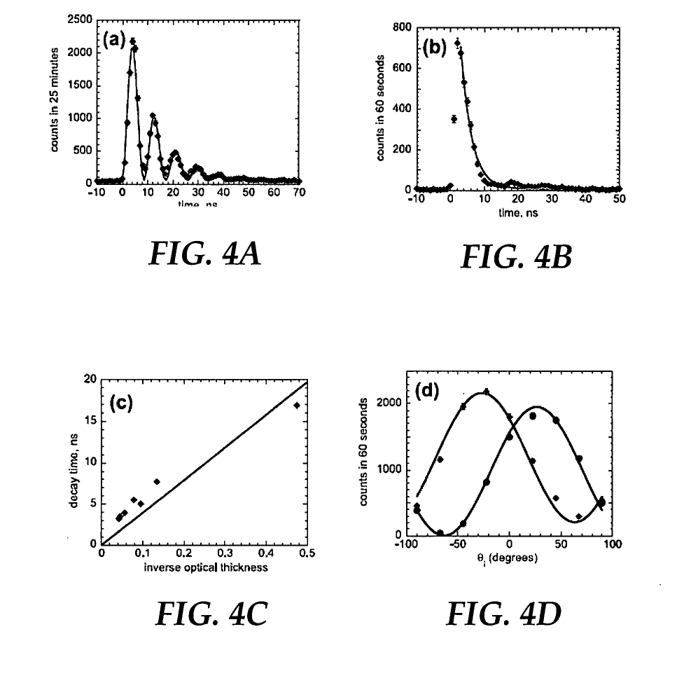

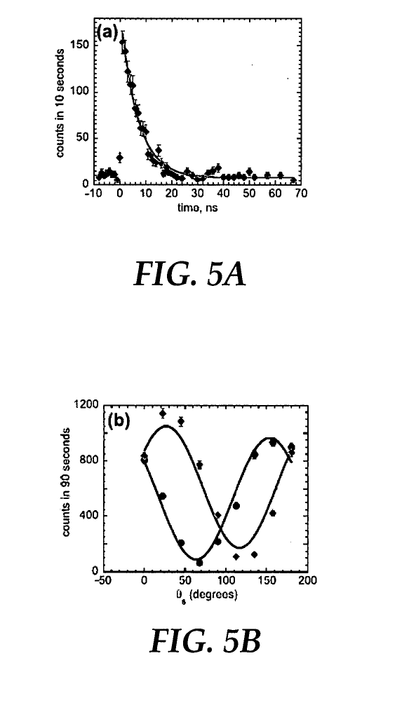

The stationary signal-idler intensity correlation function may comprise Gₛᵢ(T)=(T:Îₛ(t)Îᵢ(t+T): , where the notation T: denotes time and normal ordering of operators, and Îₛ and Îᵢ, are the signal and idler intensity operators, respectively. Results for (a) λₛ=776 nm and (b) λₛ=1.53 μm are shown in FIG. 4A-4C and FIG. 5A-5B. In particular, the measured correlation functions are shown in FIGS. 4A, 4B, and 5A. The correlation function shown in FIG. 4A exhibits quantum beats due to the two different hyperfine components of the 5p_{3/2} level. The correlation times may be consistent with superradiant scaling ˜tₛ/dₜₕ, FIG. 4C, where tₛ≈27 ns for the 5p_{3/2} level.

FIG. 4A shows count rate proportional to the signal-idler intensity correlation function Gₛᵢ as a function of signal-idler delay T, /d =|5d_{5/2}, F=4 . The quantum beats may be associated with 120 MHz hyperfine splitting, F=3 and 4, of the 5p_{3/2} level. The solid curve is a fit of the form β+A×exp(−t/α)sin²(πΩt), where β=63, A=2972, α=11 ns, and Ω=117 MHz are adjustable parameters. FIG. 4A shows the same as FIG. 4A, but for /d =|5d_{5/2}, F=5 . Since this state can only decay though the F=4 component of the 5p_{3/2} level, there are no quantum beats. The solid curve is an exponential fit with decay time of 3.2 ns. FIG. 4C shows the measured decay time vs. the inverse measured optical thickness. FIG. 4D shows measured coincidence fringes for θₛ=45° (diamonds) and θₛ=135° (circles). The solid curves are fits based on eqs. (1) and (2), with cos χ=1/^{\sqrt{5}}. FIG. 3A shows the same as FIG. 4A and FIG. 4B, but for |d =|4d_{5/2}, F=5 . The solid curve is an exponential fit with decay time of 6.7 ns. FIG. 5B shows measured coincidence fringes for θₜ=45° (diamonds) and θᵢ=135° (circles). The solid curves are fits based on Eqs. (1) and (2), with cos χ=1/^{\sqrt{5}}.

In order to investigate polarization correlations of the signal and idler fields, they may be passed through polarizers P₁ (set at angle θ_{S}) and P₂ (set at angle θᵢ), respectively, as shown in FIG. 3B. The time-resolved counting rate may be integrated over a window ΔT centered at the maximum of the signal-idler intensity correlation function Gₛᵢ(T), with (a) ΔT=6 ns for λₛ=776 nm, and (b) ΔT=1 ns for λₛ,=1.53 μm. The resulting signal-idler coincidence rate C(θ_{S}, θᵢ) exhibits sinusoidal variation as a function of the polarizers' orientations, as shown in FIG. 4D and FIG. 5B. In order to verify the predicted polarization entanglement, violation of Bell's inequality for S≦2 may be checked. The correlation function E(θ_{S}, θᵢ) may be checked, given by:

$$\frac{C ( {θ}_{s} , {θ}_{i} ) + C ( {θ}_{s}^{⊥} , {θ}_{i}^{⊥} ) - C ( {θ}_{s}^{⊥} , {θ}_{i} ) - C ( {θ}_{s} , {θ}_{i}^{⊥} )}{C ( {θ}_{s} , {θ}_{i} ) + C ( {θ}_{s}^{⊥} , {θ}_{i}^{⊥} ) + C ( {θ}_{s}^{⊥} , {θ}_{i} ) + C ( {θ}_{s} , {θ}_{i}^{⊥} )} , \\ where$$

$${θ}^{⊥} = θ + π / 2 , \\ and$$

$$S = \vert E ( {θ}_{s} , {θ}_{i} ) + E ( {θ}_{s}^{′} , {θ}_{i} ) \vert + \vert W ( {θ}_{s} , {θ}_{i}^{′} ) - E ( {θ}_{s}^{′} , {θ}_{i}^{′} ) \vert .$$

Measured values of E(θ_{S}, θᵢ), using the set of angles θ_{S}, θᵢ, chosen to maximize the violation of Bell's inequality, are presented in Table 1. For example, Table 1 shows measured correlation function E(θₛ, θᵢ) and S for λₛ=776 nm and λₛ=1.53 μm. It may be found that (a) S=2.185±0.025 for λₛ,=776 nm, and (b) S=2.132±0.036 for λₛ,=1.53 μm, consistent with polarization entanglement of signal and idler fields in both cases. The entangled two-photon state of Eqs. (1) and (2), for sin χ=2/^{\sqrt{5}}, has a substantial degree of asymmetry. If oppositely, circularly, polarized pumps I and II were used, the corresponding two-photon state would be symmetric with sin χ=cos χ=1/^{\sqrt{2}}.

TABLE 1

| λₛ | | θₛ | θᵢ | E(θₛ, θᵢ) |
|---|---|---|---|---|
| 776 | nm | 0° | −67.5° | −0.670 ± 0.011 |
| | | 45° | −22.5° | −0.503 ± 0.013 |
| | | 0° | −22.5° | 0.577 ± 0.012 |
| | | 45° | −67.5° | −0.434 ± 0.014 |
| | | | | S = 2.185 ± 0.025 |
| 1.53 | μm | 22.5° | 45° | −0.554 ± 0.027 |
| | | 67.5° | 0° | −0.682 ± 0.027 |
| | | 22.5° | 0° | 0.473 ± 0.024 |
| | | 67.5° | 45° | −0.423 ± 0.029 |
| | | | | S = 2.132 ± 0.036 |

The quantum repeater protocol may involve sequential entanglement swapping via Hong-Ou-Mandel (HOM) interference followed by coincidence detection. High-visibility HOM interference requires that the signal and idler photon wave packets have no entanglement in the time or frequency domains. This may be achieved with excitation pulses that are far detuned from two-photon resonance and with pulse lengths much shorter than the superradiant emission time tₛ/dₜₕ of level |e .

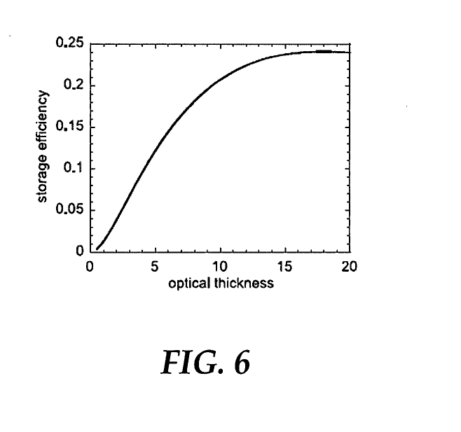

The idler field qubit is suited for conversion into an atomic qubit encoded into the collective hyperfine coherence of levels |a =|5s_{1/2}, F=3 and |b =|5s_{1/2}, F=2>. To perform such conversion, either the same or another similar ensemble or pair of ensembles could be employed. A time-dependent control laser field resonant on the |b =|5s_{1/2}, F=2 ⇄|e =|5p_{3/2}, F=3 transition could selectively convert one of the two frequency components of the idler field, shown in FIG. 4A, into a collective atomic qubit. Pulsed excitation may be used in order to enable the synchronization of the idler qubit and the control laser. Numerical simulations show that light conversion and subsequent retrieval can be done with good efficiency for moderate optical thicknesses (FIG. 6). In order to convert a qubit, the atoms may be pumped into an m=0 Zeeman state, or employ a distinct ensemble for each of the polarization components of the idler field.

FIG. 6 shows efficiency of storage and subsequent retrieval of a coherent idler field with decay time of 6 ns in an auxiliary atomic ensemble, obtained by numerical integration of the Maxwell-Bloch equations. This efficiency is independent of the storage time as long as the latter is much shorter than the atomic memory time. The control field Rabi frequency may be chosen to be 3=tₛ, and may be turned off smoothly between 10 and 30 ns after the idler enters the auxiliary ensemble. For these parameters, the maximum efficiency may be limited since the spectral width of the idler pulse is much wider than the transparency window. However, increased storage efficiency may be found using larger control field intensities.

The basic protocols outlined above can also be applied to single alkali atom emitters. Similar cascade decays in single atoms were used in early experiments demonstrating violation of local realism and single-photon generation. For alkali-metal atoms, it may be necessary to optically pump the atom into a single Zeeman state, e.g., m=0, of level |a . A virtual excitation of a single Zeeman state of level |d may be created with short laser pulses. Coherent Raman scattering to level |e may result in atom-photon polarization entanglement. In order to prevent spontaneous decay of the level |e>, a control field π pulse may be applied immediately after the application of the two-photon excitation, transferring the atomic qubit into the ground state where it could live for a long time. It is important that the π-pulse duration may be shorter than the spontaneous lifetime of level |e . Two-photon interference and photoelectric detection of signal photons produced by two remote single-atom nodes may result in entanglement of these remote atomic qubits. Qubit detection for single atoms can be achieved with nearly unit efficiency and in a time as short as 50 μs. Such high efficiency and speed lead to the possibility of a loophole-free test of Bell's inequality, for atoms separated by about 30 kilometers. Cascaded entanglement swapping between successive pairs of remote entangled atomic qubits may be achieved via local coupling of one of the atoms from the first pair and its neighboring partner from the following pair.

The cascade level scheme employed above can be used to convert a telecommunications photon into a near-infrared photon using four-wave mixing. This could potentially be useful because single-photon detectors for the visible and near-infrared currently have much higher quantum efficiency, and much lower dark count probability than practically viable [e.g., (In,Ga)As] detectors used at telecommunication wavelengths.

### Deterministic Single Photons via Conditional Quantum Evolution

Consistent with embodiments of the present invention, deterministic single photons may be provided, for example, via conditional quantum evolution. Error correction may be performed in any practical system because nothing works perfectly. For example, a quantum communication system (e.g. the one shown in FIG. 1) may need to use error correction. Consequently, an additional element in the quantum communication system may comprise a mechanism to provide a deterministic single photon.

Consistent with embodiments of the invention, a deterministic single photon may be produced using a feedback system that may operate on an atomic ensemble to determine if an excitation exists in the atomic ensemble. If the feedback system indicates that an excitation exists in the atomic ensemble, then the atomic ensemble may be hit with a laser to produce the deterministic single photon. This produced deterministic single photon may be collected and used, for example, for error correction in the quantum communication system. The feedback system may include a laser of its own that continually hits the atomic ensemble until the feedback system detects a photon emission from the atomic ensemble. When the feedback system detects the photon emission from the atomic ensemble, it may indicate that an excitation exists in the atomic ensemble.

Consistent with embodiments of the invention, a deterministic single-photon source may be provided based on an ensemble of atomic emitters, measurement, and conditional quantum evolution. The implementation of this scheme may be realized, for example, using a cold rubidium vapor, with a measured efficiency η_{D}≈1%-2%. In common with the cavity QED system, a source may be suitable for reversible quantum state transfer between atoms and light, which may be a prerequisite for a quantum network. However, unlike cavity QED implementations, it may be unaffected by intrinsically probabilistic single atom loading. Therefore, it may be stationary and may produce a photoelectric detection record with sub-Poissonian statistics.

On feature of the protocol consistent with embodiments of the invention may be that a single photon can be generated at a predetermined time if it is known that the medium contains an atomic excitation. The presence of the latter may be heralded by the measurement of a scattered photon in a write process. Since this may be intrinsically probabilistic, it may be necessary to perform independent, sequential write trials before the excitation is heralded. After this point embodiments of the invention wait and read out the excitation at a predetermined time. The performance of repeated trials and heralding measurements represents a conditional feedback process and the duration of the protocol may be limited by the coherence time of the atomic excitation. Embodiments of the invention may have, for example, two elements: (a) a high-quality probabilistic source of heralded photons; and (b) long atomic coherence times.

Heralded single-photon sources, consistent with embodiments of the invention, may be characterized by mean photon number <n> <<1, as the unconditioned state consists mostly of vacuum. Moreover, in the absence of the heralding information, the reduced density operator of the atomic excitation may be thermal. In contrast, its evolution conditioned on the recorded measurement history of the signal field in our protocol ideally results in a single atomic excitation. Conventional systems with atomic ensembles did not have sufficiently long coherence times to implement such a feedback protocol.

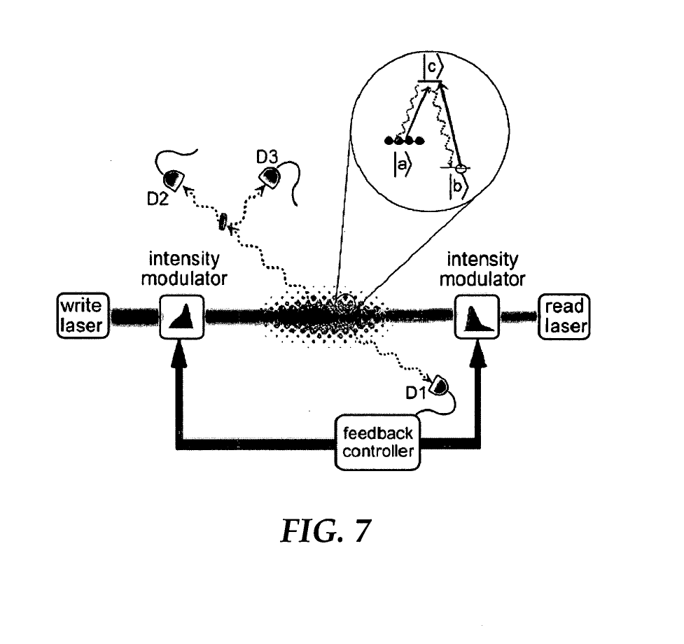

Consistent with embodiments of the invention, a process for heralded single-photon generation may be shown. FIG. 7 is a diagram showing a single-photon generation system consistent with embodiments of the invention. As shown in FIG. 7, an atomic cloud of optical thickness≈7 may be provided by a magneto-optical trap (MOT) of ⁸⁵Rb. The ground levels {|a>; |b>} may correspond to the 5S_{1/2}, Fₐ;_{b}={3,;2} hyperfine levels, while the excited level |c> represents the {5P_{1/2}, F_{c}=3} level of the D₁ line at 795 nm. The process may start with all of the atoms prepared in level |a>. An amplitude modulator generates a linearly polarized 70 ns long write pulse tuned to the |a>→|c> transition, and focused into the MOT with a Gaussian waist of about 430 μm. The write process may be described using a simple model based on nondegenerate parametric amplification. The light may induce spontaneous Raman scattering via the |c>→|b> transition. The annihilation of a write photon creates a pair of excitations: namely, a signal photon and a quasibosonic collective atomic excitation. The scattered light with polarization orthogonal to the write pulse may be collected by a single-mode fiber and directed onto a single-photon detector D1, with overall propagation and detection efficiency ηₛ. Starting with the correlated state of signal field and atomic excitation, the vacuum may be projected out from the state produced by the write pulse using the projection operator: \hat{l}−e^{-d̂d}:, where \hat{d}=\sqrt{ηₛ}âₛ+\sqrt{1−ηₛ}\hat{ξ}ₛ, â, is the detected single mode and \hat{ξ}, is a bosonic operator accounting for degrees of freedom other than those detected. Tracing over the signal and all other undetected modes, we find that the density matrix for the atomic excitation A conditioned on having at least one photoelectric detection event is given by:

$${ρ}_{A \vert 1} = \frac{1}{{p}_{1}} {\sum }_{n = 1}^{∞} \frac{{tanh}^{2 n} χ}{{cosh}^{2} χ} ( 1 - {( 1 - {η}_{s} )}^{n} ) \vert n 〉 〈 n \vert , \qquad ( 1 )$$

where p₁<<1 is the probability of a signal photoelectric detection event per write pulse, and the interaction parameter χ is given in terms of p₁ and η_{S} by:

sin h²χ=p₁/[ηₛ(1−p₁)], (2)

where where |n>≡Â^{†n}|0>/\sqrt{n!}, and |0> is the atomic vacuum. Note that in Eq. (1) there is zero probability to find |0>.

After a storage time τ, a read pulse of length 80 ns containing, for example, 3×10⁷ photons, and with polarization orthogonal to that of the write pulse, tuned to the |b>→|c> transition, illuminates the atomic ensemble (FIG. 7.) For example, the read pulse may convert atomic spin excitations into the idler field emitted on the |c>→|a> transition. The elastically scattered light from the write beam may be filtered out, while the idler field polarization orthogonal to that of the read beam may be directed into, for example, a 50:50 single-mode fiber beam splitter. Both write-read and signal-idler pairs of fields may be counterpropagating. The waist of the signal-idler mode in the MOT ma be about 180 μm. The two outputs of the fiber beam splitter may be connected to detectors D2 and D3. Electronic pulses from the detectors may be gated with 120 ns (D1) and 100 ns (D2 and D3) windows centered on times determined by the write and read light pulses, respectively. Subsequently, the electronic pulses from D1, D2, and D3 may be fed into a time-interval analyzer which records photoelectric detection events with a 2 ns time resolution.

The transfer of atomic excitation to the detected idler field at either Dk (k=2, 3) may be given by a linear optics relation âₖ=\sqrt{ηᵢ(τ)/2}Â+\sqrt{1−ηᵢ(τ)/2}\hat{ξ}ₖ(τ). where âₖ depends parametrically on τ and corresponds to a mode with an associated temporal envelope φ(t)., normalized so that ∫₀^{∞}dt|φ(t)|²=1, and \hat{ξ}ₖ(τ) is a bosonic operator which accounts for coupling to degrees of freedom other than those detected. The efficiency ηᵢ(τ)/2 may be the probability that a single atomic excitation stored for τ results in a photoelectric event at Dk, and includes the effects of idler retrieval and propagation losses, symmetric beam splitter (factor of ½) and nonunit detector efficiency. We start from the elementary probability density Q_{k|1}(t_{c}). for a count at time t_{c} and no other counts in the interval [0, t_{c}), Q_{k|1}(t_{c})=|φ(t_{c})|²(:âₖ^{†}âₖ exp(−∫₀^{t}^{_{c}}dt|φ(t)|²âₖ^{†}âₖ):<. Using Eq. (1), the probability p_{k|1}≡∫₀^{∞}dtQ_{k|1}(τ) can be calculated that detector Dk registers at least one photoelectric detection event. Similarly, the probability p_{23|1} of at least one photoelectric event occurring at both detectors may be calculated. These probabilities may be given by

p_{2|1}(τ)=p_{3|1}(τ)=Π(ηᵢ(τ)/2; p₁, ηₛ), (3)

p_{23|1}(τ)=p_{2|1}(τ)+p_{3|1}(τ)−Π(ηᵢ(Π); p₁, ηₛ), (4)

where we show the explicit dependence on τ. Here 1—Π(η; p₁, ηₛ) given by

$$\frac{1}{{p}_{1}} ( \frac{1}{1 + η {sinh}^{2} χ} - \frac{1}{1 + ( {η}_{s} + η ( 1 - {η}_{s} ) ) {sinh}^{2} χ} ) .$$

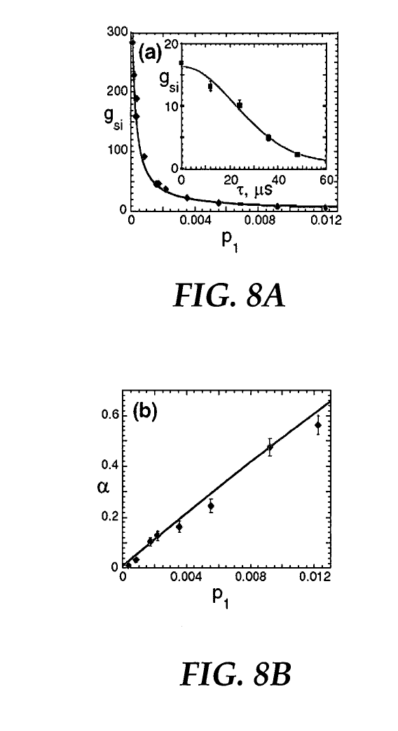

The conditional quantum evolution protocol may transform a heralded single-photon source into a deterministic one. The requirements for this transformation may comprise higher efficiency and longer memory time of the heralded source than those previously reported. FIGS. 8A and 8B show the results of a characterization of an improved source of heralded single photons. FIG. 8A shows a measured intensity cross-correlation function gₛᵢ=[p_{2|1}+p_{3|1}]/[p₂+p₃] function of p₁. Large values of gₛᵢ under conditions of weak excitation—i.e., small p₁—indicate strong pairwise correlations between signal and idler photons. The efficiency of the signal photon generation and detection may be given by ηₛ→gₛᵢp₁, in the limit sin h²χ<<1. It may be measured ηₛ≈0.08. which includes the effects of passive propagation and detection losses εₛ. It may be important to distinguish the measured efficiency from the intrinsic efficiency which is sometimes employed. The intrinsic efficiency of having a signal photon in a single spatial mode at the input of the single-mode optical fiber ηₛ⁰≡(ηₛ/εₛ)≈0.24 We measure εₛ≡εₛ^{f}εₛ^{t}εₛ^{d}≈0.3 independently using coherent laser light, where the fiber coupling efficiency εₛ^{f}≈0.7, optical elements transmission εₛ^{t}≈0.85, and the detection efficiency εₛ^{d}≈0.55. The measured efficiency of the idler photon detection is ηᵢ→gₛᵢ(p₂+p₃)≈0.075. Here p₂ and p₃ may be defined by expressions analogous to Eq. (2). Similarly, the intrinsic efficiency for the idler field ηᵢ⁰≡(ηᵢ/εᵢ)≈0.34, where we measure εᵢ≡εᵢ^{f}εᵢ^{t}εᵢ^{d}≈0.22, with εᵢ^{f}≈0.75. εᵢ^{t}≈0:59, and εᵢ^{d}≈0.55.

The quality of the heralded single photons produced by embodiments of the invention may be assessed using a procedure that involves a beam splitter followed by two single-photon counters. An ideal single-photon input to the beam splitter may result in photo-electric detection at either D2 or D3 (FIG. 7), but not both. An imperfect single-photon input may result in strong anticor-relation of the coincidence counts. Quantitatively, this may be determined by the anticorrelation parameter a given by the ratio of various photoelectric detection probabilities measured by the set of detectors D1, D2, and D3: a=p_{23|1}/(p_{2|1}p_{3|1}). Classical fields may satisfy a criterion a≧1 based on the Cauchy-Schwarz inequality. For an ideally prepared single-photon state: α→0. FIG. 8B shows the measured values of α as a function of p₁, with min{a}=0:012±0:007 representing a tenfold improvement on the lowest previously reported value in atomic ensembles.

In order to evaluate the atomic memory coherence time t_{c}, gₛᵢ may be measure as a function of the storage time τ, as shown in FIG. 8A. To maximize t_{c}, the quadrupole coils of the MOT may be switched off, with the ambient magnetic field compensated by three pairs of Helmholtz coils. The measured value of τ_{c}≈31.5 μs, may be limited by dephasing of different Zeeman components in the residual magnetic field.

The long coherence time may enable implementation of a conditional quantum evolution protocol. In order to generate a single photon at a predetermined time tₚ, we initiate the first of a series of trials at a time tₚ−Δt, where Δt is on the order of the atomic coherence time: τ_{c}. Each trial begins with a write pulse. If D1 registers a signal photoelectric event, the protocol is halted. The atomic memory is now armed with an excitation and is left undisturbed until the time tₚ when a read pulse converts it into the idler field. If D1 does not register an event, the atomic memory is reset to its initial state with a cleaning pulse, and the trial is repeated. The duration of a single trial t₀=300 ns. If D1 does not register a heralding photoelectric event after N trials, the protocol is halted 1:5 ps prior to tₚ, and any background counts in the idler channel are detected and included in the measurement record.

The unconditioned detection and coincidence probabilities for the complete protocol may be calculated using Eqs. (3) and (4). The probability that the atomic excitation is produced on the jth trial is p₁(I−p₁)^{j}−¹. This excitation is stored for a time (N−j)t₀ before it is retrieved and detected; N=Δt/t_{Q} is the maximum number of trials that can be performed in the protocol (the 1:5 μs halting period may be ignored before the readout).

The probability of a photoelectric event at Dk (k=2, 3), Pₖ, and the coincidence probabilities P₂₃ in terms of the conditional probabilities of Eqs. (3) and (4) can be expressed,

$${P}_{μ} = {p}_{1} {\sum }_{j = 1}^{N} {( 1 - {p}_{1} )}^{j - 1} {p}_{μ \vert 1} ( Δ t - {jt}_{0} ) . \qquad ( 5 )$$

μ=2, 3, 23. In the limit of infinite atomic coherence time and N→∞, P_{μ}→p_{μ|1}. Hence, if the memory time is sufficiently long for an adequate number of trials, the protocol may result in deterministic preparation of a single atomic excitation, which can be converted into a single photon at a desired time. Consistent with FIG. 8A, it may be assumed a combined retrieval-detection efficiency that decays as a Gaussian function of storage time, ηᵢ(τ)=ηᵢ(0)e^{-(τ/τ}^{_{c}}⁾^{²}, where τ_{c} is the atomic spin-wave coherence time.

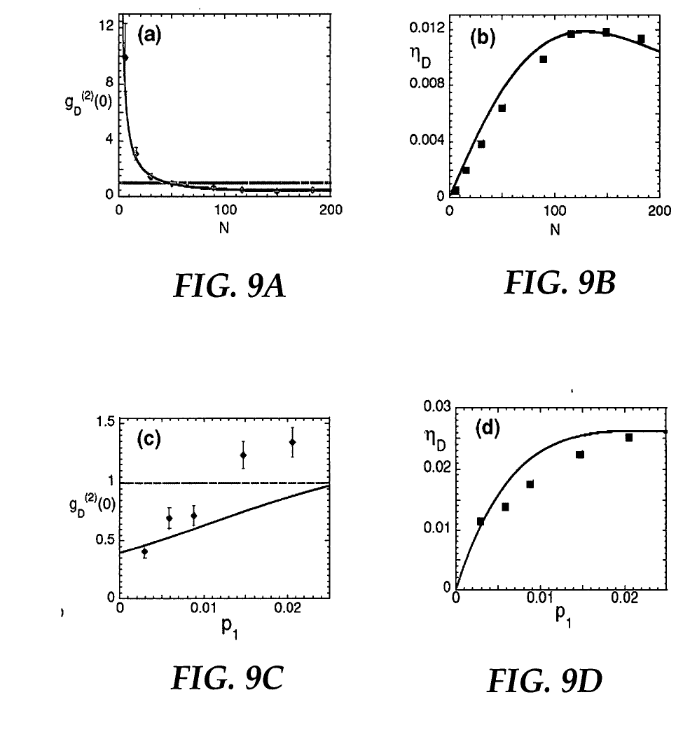

FIG. 9A through 9D present the measured degree of 2nd order coherence for zero time delay g_{D}⁽²⁾(0)=P₂₃/(P₂P₃) and the measured efficiency η_{D}=P₂+P₃ as a function of p₁ (FIGS. 9A and 9B), and as a function of p₁ (FIGS. 9C and 9D). The solid curves are based on Eq. (5). The dashed lines in FIGS. 9A and 9B show the expected value of g_{D}⁽²ⁱ(0)=1 for a weak coherent state (as we have confirmed in separate measurements). The particular value of Δt is chosen to optimize g_{D}⁽²⁾(0) and η_{D}. The minimum value of g_{D}⁽²⁾(0)=0.41±0.04 indicates substantial suppression of two-photon events and under the same conditions η_{D}=0:012. As shown in FIG. 9A, when N is small, the protocol does not result in deterministic single photons. Instead, the cleaning pulse-induced vacuum component of the idler field leads to additional classical noise. Large N, and hence long coherence times, are crucial to reduce this noise below the coherent state level and to approach a single-photon source. Note that in the limit of infinite atomic memory and N→∞, g_{D}⁽²⁾(0)→min{α}≈0.012±0.007 and η_{D}→ηᵢ˜0.075, substantially exceeding the performance of any demonstrated deterministic single-photon source.

Moreover, η_{D} can be further increased with a larger optical thickness and by optimizing the spatial modes of the signal and idler fields. The spatial signal-idler correlations from an atomic ensemble (and, therefore ηᵢ⁰.) can also be improved by use of an optical cavity. However, in the absence of special precautions the use of a cavity may introduce additional losses associated, e.g., with the mirror coatings or the cavity locking optics. The measured efficiency η_{D} would involve a trade-off between improved spatial correlations due to the cavity and the concomitant losses that it introduces.

### Multiplexed Memory-Insensitive Quantum Repeaters

Consistent with embodiments of the present invention, multiplexed memory-insensitive quantum repeaters may be provided. Using multiplexed memory-insensitive quantum repeaters, for example, may greatly increase the transmission rates that may be achieved with conventional systems over long distances. Embodiments of the invention may subdivide the gas (e.g. vapor) in a storage element comprises an atomic ensemble. For example, the gas may be subdivided into independent elements each of which may function as a memory element itself. Consequently, by using the subdivided independent elements appropriately (i.e. multiplexing), transmission rates may be achievable that are much greater than could be achieved without multiplexing.

Long-distance quantum communication via distant pairs of entangled qubits may comprise a first step towards technologies such as perfectly secure message transmission and distributed quantum computing. Accordingly, quantum repeaters may be used to mitigate the exponential decrease in communication rate due to optical fiber losses. However, quantum repeaters may be sensitive to the lifetimes of the memory elements they use. Consistent with embodiments of the invention, system and methods based on a real-time hardware reconfiguration of multiplexed quantum nodes may be used. Embodiments of the invention may include multiplexed quantum repeater networks that are largely insensitive to the coherence times of quantum memory elements.

Quantum communication, networking, and computation schemes may utilize entanglement between several elements as a resource. This entanglement enables phenomena such as quantum teleportation and secure quantum communication. It is the generation of the entangled states, and the distance over which they may be physically separated, that determines the maximum range of quantum communication devices. The difficulty in implementing a practical quantum repeater may be connected to short atomic memory coherence times and large loss rates in the transmission channels. Accordingly, embodiments of the invention may provide quantum memory elements for the telecommunication window with the coherence times necessary for intra-continental communication.

Consistent with embodiments of the invention, entanglement generation and connection architecture using a real-time reconfiguration of multiplexed quantum nodes may be provided. This may improve communication rates for short memory times. Embodiments of the invention may be implemented using atomic ensembles-based memory elements.

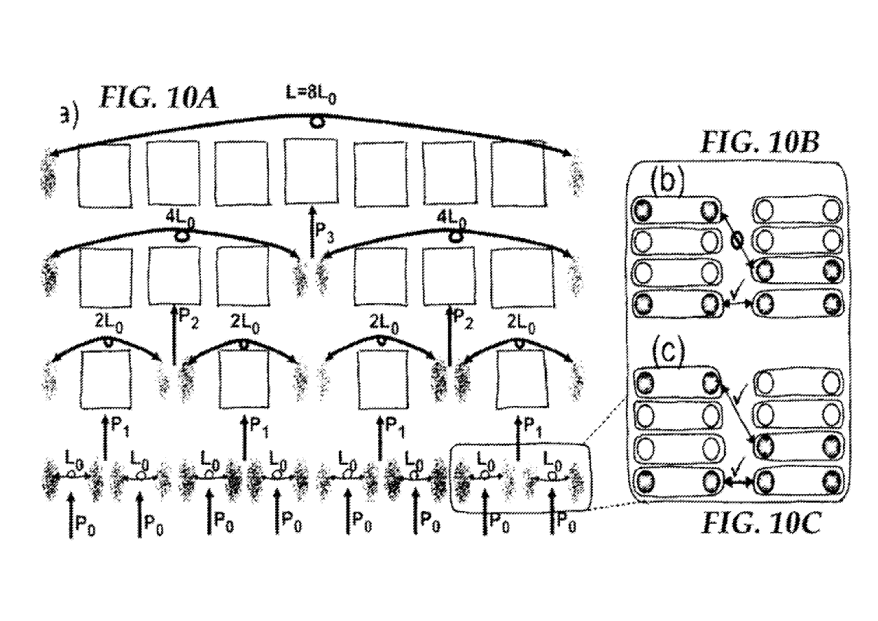

FIGS. 10A through 10C show a quantum repeater consisting of 2^{N}+1 distinct nodes. A first step may include generating entanglement between adjacent memory elements in successive nodes. Each such process may succeed with probability P₀. After entanglement generation, an entanglement connection process may be employed that extends entanglement lengths from L₀ to 2L₀, using either a parallelized (FIG. 10B), or multiplexed (FIG. 10C) architecture. This first entanglement connection succeeds with probability P₁, followed by subsequent entanglement-length doublings with probabilities P₂, . . . ,Pₙ, until the terminal quantum memory elements, separated by L=2^{N}L₀, are entangled. For the simplest case of entanglement-length doubling with a single memory element per site (N=n=1), we calculate the average time to successful entanglement connection for both ideal (infinite) and finite quantum memory lifetimes. This basic process is fundamental to the operation of the more complex N-level quantum repeaters. In essence, an N-level quantum repeater can be considered as a single entanglement connection of two (N−1)-level systems.

FIG. 10A shows successive entanglement connection processes of an N=3 multiplexed quantum repeater which entangle quantum memory element nodes separated by a distance L. In addition to these two terminal nodes the network has, for example, seven internal nodes, each consisting of a pair of quantum memory sites. All sites contain n independent memory elements. Entanglement generation proceeds between elements in adjacent memory sites with probability P₀, creating entanglement in each segment of length L₀. In the lowest panel, shaded memory sites indicate eight successfully entangled segments. At the N=1 level, entanglement connection between memory elements in alternate internal nodes proceeds with probability of success P₁, resulting in entanglement-length doubling and four entangled segments of length 2L₀. The successfully connected nodes are shaded, while the nodes reset to their vacuum states are blank. The N=2 and N=3 levels produce similar entanglement connections with success probabilities P₂ and P₃, respectively. In each case these connections result in entanglement-length doubling operations, until success at the N=3 level leaves the terminal nodes entangled, as shown in the upper-most panel. FIGS. 10B and 10C show the topology of the n memory element sets within two adjacent segments. The parallel communication architecture, (FIG. 10A), connects entanglement only between memory elements with the same address. In contrast, multiplexing (FIG. 10C) uses a fast sequential scanning of all memory element addresses within a node to enable the connection of any available memory elements at the appropriate site.

A random variable Z may be defined to be the waiting time for an entanglement connection attempt, involving measurements on the two internal memory elements (from here on times are measured in units of L₀/c, where the speed of light c includes any material refractive index). The random variable Y=1 if entanglement connection succeeds and zero otherwise. The time for each entanglement generation attempt is taken to be unity, as is the time required for each entanglement connection attempt. The total time to the first success is the sum of the waiting time between connection attempts and the time spent in unsuccessful trials,

T=(Z₁+1)Y₁+(Z₁+Z₂+2)(1−Y₁)Y₂+(Z₁+Z₂+Z₃+3)(1−Y₁)(1−Y₂)Y₃+ . . . , (1)

from which it follows that

$$〈 T 〉 = \frac{〈 Z 〉 + 1}{{P}_{1}} , \qquad ( 2 )$$

since Z and Y are independent random variables. In the infinite memory time limit, Z is simply the waiting time until entanglement is present in both segments, i.e., Z=max{A, B}, where A and B are random variables representing the entanglement generation waiting times in the left and right segments. As each entanglement generation attempt is independent of previous attempts, A and B are both geometrically distributed with success probability P₀. Using the properties of the maximum of two geometrically distributed random variables, it follows that,

$${〈 T 〉}_{∞} = \frac{3 - {P}_{0}^{2}}{{P}_{0} {P}_{1} ( 2 - {P}_{0} )} . \qquad ( 3 )$$

Embodiments of the invention may comprise entanglement-length doubling with finite memory elements. For finite quantum memory elements Eqs. (1) and (2) still hold, but Z may no longer be simply max{A, B}. Rather it may be the waiting time until the left and right segments are entangled within T time units of each other, where T is the quantum memory lifetime. For simplicity, it may be assumed that the quantum memory acts as a step function. That is, entanglement is unaffected for T, and destroyed thereafter. The variables A and B are defined as in the ideal case above. A new random variable M=1 if |A−B|≦T and zero otherwise. As A and B are geometrically distributed, Z is then given by,

$$Z = max \{ {A}_{1} , {B}_{1} \} {M}_{1} + ( min \{ {A}_{1} , {B}_{1} \} + τ + max \{ {A}_{2} , {B}_{2} \} ) ( 1 - {M}_{1} ) {M}_{2} + … \qquad ( 4 )$$

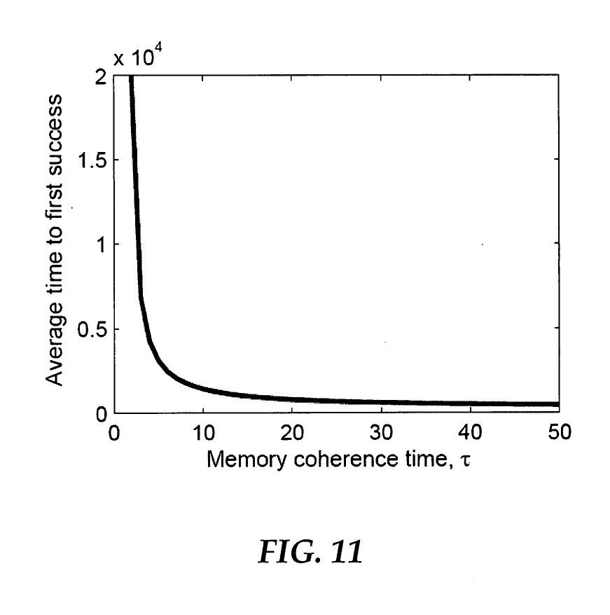

From this and Eq. (2) it follows that

$${〈 T 〉}_{τ} = \frac{{〈 T 〉}_{∞} - ( \frac{1 + {P}_{0}}{{P}_{0} {P}_{1}} ) \frac{{q}_{0}^{τ + 1}}{1 - {P}_{0} / 2}}{1 - \frac{{q}_{0}^{τ + 1}}{1 - {P}_{0} / 2}} , \qquad ( 5 )$$

Where q₀≡1−P₀. Since the entanglement generation probability suffers from transmission losses, P₀ is typically small compared to P₁. FIG. 11 illustrates the characteristically sharp increase in (T)_{T} for small T. This suggests that more complex quantum repeaters will exhibit even poorer scaling, as N-level repeaters require many entanglement-length doubling successes.

Embodiments of the invention may include parallelization and Multiplexing. Because achievement of long coherence times is desired, approaches that might circumvent the poor scaling behavior at low memory times are desired. Accordingly, embodiments of the invention may include a system that compensates for low success rates by increasing the number of trials, placing n>1 memory elements (element pairs) in each external (internal) node. This improves the chance of generating entanglement.

Consistent with embodiments of the invention, there are two basic ways to utilize this entanglement: parallelization and multiplexing. In the parallel scheme, the i^{th} memory element pair in one node interacts only with the i^{th} pair in other nodes, FIG. 10B. Thus, a parallel quantum repeater with n2^{N+1} total memory elements acts as n independent 2^{N+1}-element repeaters and connects entanglement n times faster.

Consistent with embodiments of the invention, another approach is to dynamically reconfigure the connections between nodes, using information about entanglement successes to determine which nodes should be connected. In this multiplexed scheme, the increased number of node states that allow entanglement connection, compared to the parallel case, suggests an improved entanglement connection rate between the terminal nodes.

The entanglement connection rate of an N=1 multiplexed system may be calculated. Unlike the parallel scheme, however, the entanglement connection rate may no longer simply relate to the average time to the first success (T)_{T}. Whenever one segment has more entangled element pairs than its partner, entanglement connection attempts do not reset the repeater to its vacuum state. Under this circumstance residual entanglement remains. Simultaneous successes and residual entanglement produce average times between successes smaller than (T)_{T}. When residual entanglement is significantly more probable than simultaneous successes, we can approximate the resulting repeater rates. This is certainly the case in both the low memory time limit and whenever nP₀<<1. This approximation involves modifying the expression for the entanglement generation waiting time by including cases where the waiting time is zero due to residual entanglement. In Z of Eq. (4), the min {Aⱼ, Bⱼ} terms represent the waiting time to an entanglement generation success starting from the vacuum state. We modify min {Aⱼ, Bⱼ}→α min {Aⱼ, Bⱼ}, where 1-α is the probability of residual entanglement. With this change, Eq. (4) now produces the average time between successes. Using Eq. (2), the resulting rate is given by

$${〈 f 〉}_{τ , n} = \frac{{P}_{1} ( 1 - {q}_{0}^{n} ) ( 1 + {q}_{0}^{n} - 2 {q}_{0}^{n ( τ + 1 )} )}{1 + 2 {q}_{0}^{n} - {q}_{0}^{2 n} - 4 {q}_{0}^{n ( τ + 1 )} + 2 {q}_{0}^{n ( τ + 2 )} + α} , \\ where \\ log α ≡ \frac{2 {q}_{0}^{n} ( 1 - {q}_{0}^{n τ} ( 2 - {q}_{0}^{n} ) )}{1 - {q}_{0}^{2 n}} ( n - 1 ) log {q}_{0} . \qquad ( 6 )$$

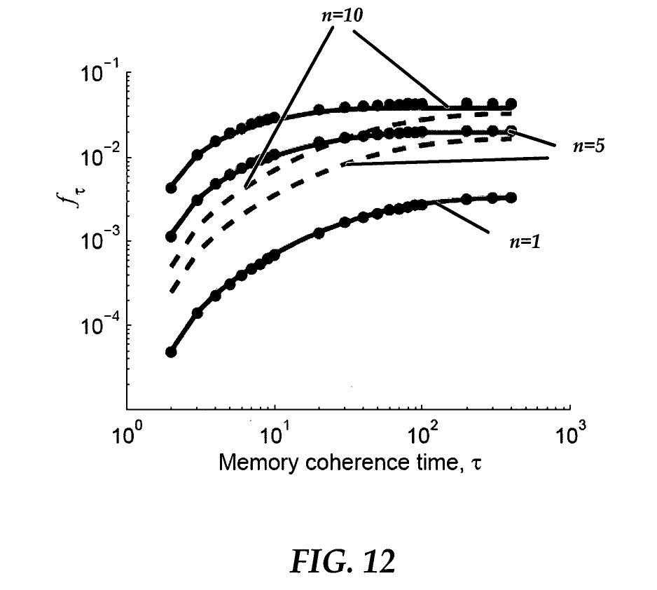

FIG. 12 shows a comparison of the entanglement connection rates of the multiplexed ( f _{T,n}) and parallel (n f _{T}, 1) architectures for several different n values against a computer simulation of the multiplexed case. Multiplexed entanglement connection rates do exceed those of the equivalent parallelized repeaters. The improvement from multiplexing in the infinite memory case is comparatively modest. However, the multiplexed connection rates are dramatically less sensitive to decreasing memory lifetimes when compared to parallelized systems. We note that for the given parameters the performance of the n=5 multiplexed repeater exceeds that of its n=10 parallelized counterpart, reflecting a fundamental difference in their dynamics and scaling behavior.

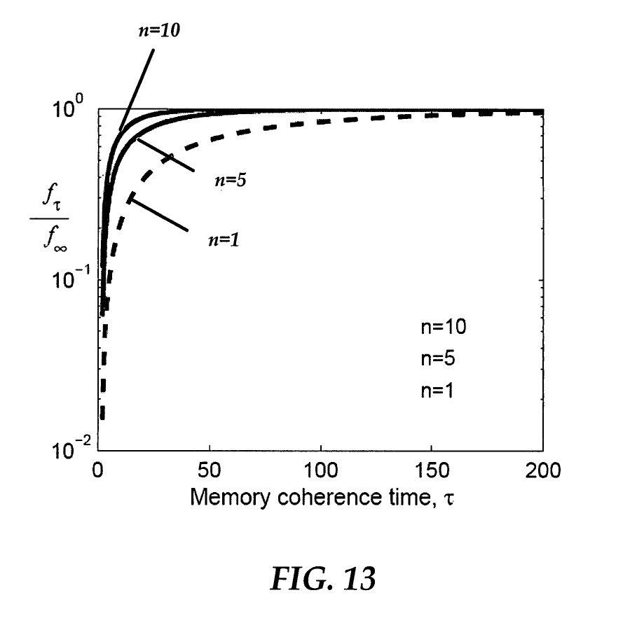

To further illustrate the memory insensitivity of multiplexed repeaters, the fractional entanglement connection rate, relative to the infinite memory limit, for several values of n is shown in FIG. 13. As parallelized rates scale by the factor n, such repeaters all follow the same curve, assuming identical system parameters. By contrast, multiplexed repeaters become less sensitive to coherence times as n increases. This improved performance in the low memory limit is a characteristic feature of the multiplexed architecture.

Consistent with embodiments of the invention, N-level quantum repeaters may be provided. To calculate entanglement connection rates for N>1 repeaters, computer simulation may be used. The qualitative behavior of the connection rates remains similar to the N=1 case. Furthermore, the N=1 analysis provides a check of the simulation results.

To simulate an N-level quantum repeater requires a specific choice of entanglement connection probabilities. We choose the particular physical implementation proposed by DLCZ. For the DLCZ protocol, one may specify the total distance L, the number of segments 2^{N}, the loss γ of the fiber connection channels, and the efficiency η of retrieving and detecting an excitation created in the atomic ensemble based quantum memory elements.

The entanglement generation probability is given by P0=η₀ exp(−γL₀/2), where η₀ is related to the fidelity F≈1−η₀. A set of recursion relations gives the entanglement connection probabilities as a function of η: Pᵢ=(η/(cᵢ₋₁+1))(1−η/(2β(cᵢ₋₁+1))), cᵢ=2 cᵢ₋₁+1−η/β, i=1, . . . N. Neglecting detector dark counts, c₀=0. Here β=1 for photon number resolving detectors (PNRDs) whereas β=2 for non-photon resolving detectors (NPRDs). Though the two sets of recursion relations appear similar, there is an important physical difference: in the NPRD case, even ideal retrieval and detection efficiencies, η=1, result in decreasing entanglement connection probabilities, Pᵢ₊₁<Pᵢ. In the PNRD case, ideal detectors result in constant connection probabilities, Pᵢ₊₁=Pᵢ. For values of η<1 photon losses result in a vacuum component of the connected state in either case. For NPRDs, the inability to distinguish between one- and two-photon pulses leads to an additional vacuum contribution. Removing the vacuum component requires a final projective measurement, which succeeds with probability ε=1/(c₃+1).

Consider a 1000 km communication link. Assume a fiber loss of 10γ/ln 10=0.16 dB/km, η0=0.05, and a photonic retrieval and detection efficiency of η=0.5. Taking N=3 (L₀=125 km) results in the entanglement generation probability P₀=0.005. For concreteness, we treat the NPRD case. The above recursion relationships for NPRDs produce the entanglement connection probabilities: P₁=0.4375, P₂=0.2655, P₃=0.1479, and ε=0.16.

We begin by comparing the N=1 analysis in Eqs. (3), (5), and (6) with simulated N=1 results. Returning to FIG. 12 we observe that the simulation agrees well with both the exact predictions for n=1, and the approximate predictions for n>1. The slight discrepancies in the long memory time limit for larger n are quite uniform and are well understood from the influence of simultaneous connection successes, which were neglected in our analytic approximation. This produces predicted rates which, as expected, are slightly lower than the simulated results.

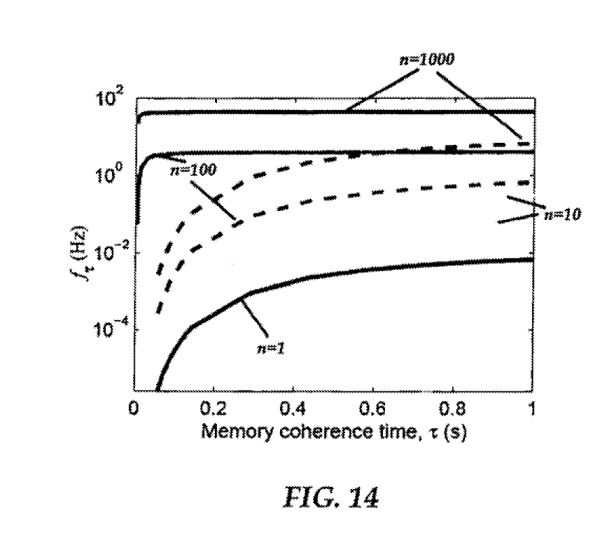

An N-level quantum repeater succeeds in entanglement distribution when it has entangled the terminal nodes with each other. FIG. 14 shows the entanglement distribution rate of a 1000 km N=3 quantum repeater as a function of the quantum memory lifetime. We note the same characteristic memory insensitivity as in the multiplexed N=1 repeater discussed earlier. Remarkably, for multiplexing with n≧10 the entanglement distribution rate is essentially constant for coherence times over 100 ms. For memory lifetimes close or equal to the absolute minimum, set by the light-travel time between the terminal nodes, multiplexed repeaters with n≧10 produce rates over a billion times faster than the equivalent parallel cases (not visible on the scale shown). We note that, for memory coherence times of less than 175 ms, one achieves higher entanglement distribution rates by multiplexing ten memory element pairs per segment than parallelizing 1000.

FIG. 14 shows entanglement distribution over 1000 km. For example, FIG. 14 shows simulated entanglement distribution rates for multiplexed (solid) and parallel (dashed) N=3 quantum repeaters employing the DLCZ protocol with NPRDs for a range of n. The fiber loss, entanglement generation and connection probabilities are given in the text. Due to their larger simulation times, the n=1 and parallel cases are simulated only for coherence times exceeding 60 ms. For coherence times longer than 100 msec, the entanglement distribution rate of multiplexed repeaters is almost flat for n≧10. Over the same range, parallelized repeater rates decrease by two orders of magnitude. Note that in the low memory region the multiplexed n=10 repeater outperforms an n=1000 parallel quantum repeater.

The DLCZ protocol may require two separate entanglement distributions, within t₀, to communicate a single quantum bit, followed by two separate local measurements. Suppose the average success rate of entanglement distribution is f. The average probability of success within the requisite window t₀ is pₛ≅[1−(1−f)^{t0}]². The subsequent measurements involve the photonic retrieval and detection with efficiency η, and only half of the possible configuration states result in successful communication. This gives a communication rate of R=η²pₛ/2. It may be necessary that t₀<T, as memory time is consumed during the entanglement distribution process. The effects of dark counts, phase fluctuations, and other various sources of error have not been considered. When these are non-negligible, standard linear-optics-based purification techniques could be applied to the multiplexing protocols consistent with embodiments of the invention.

Embodiments of the invention may include multiplexing with atomic ensembles. A multiplexed quantum repeater could be implemented using cold atomic ensembles as the quantum memory elements. Embodiments of the invention may subdivide the cold atomic gas into n independent ensembles, each of which constitutes an individually addressable memory element, FIG. 10(C). Dynamic addressing can be achieved by fast (sub-microsecond), two-dimensional scanning using acousto-optic modulators, which allow the coupling of each memory element to the same single-mode optical fiber. As an example, consider a cold atomic sample 400 μm in cross-section, confined in a three-dimensional far-detuned optical lattice. Assuming the addressing laser beams have waists of 20 μm, multiplexing n>100 memory elements is feasible. By employing the magnetically-insensitive atomic clock transition in the optically confined sample, it may be possible to extend the storage time to tens of milliseconds. This should enable the implementation of multiplexed protocols, such as those proposed, sufficient for practical quantum communication over 1000 km, for example.

Accordingly, the multiplexed repeater architecture consistent with embodiments of the invention greatly magnifies the impact of advances in quantum memory elements, translating each incremental advance in memory times into significant extensions in the range of quantum communication devices. The improved scaling outperforms massive parallelization with ideal detectors. These results are independent of the particulars of the entanglement generation and connection protocol. Ion-, atom-, and quantum dot-based systems should all benefit from multiplexing.

Entanglement of Dual Species Matter Qubits with Light

Consistent with embodiments of the present invention, dual species matter qubits may be entangled with light. For example, a storage element may comprise an atomic ensemble having a volume. The volume may comprise a first isotope vapor configured to store a first state of a qubit. In addition, the volume may comprise a second isotope vapor configured to store a second state of the qubit. Consistent with embodiments of the present invention, the first state of the qubit stored in the first isotope vapor and the second state of the qubit stored in the second isotope vapor may be entangled with a frequency encoded optical qubit.

Consistent with embodiments of the invention, interferometrically robust atomic qubits based, for example, on co-trapped cold ensembles of two rubidium isotopes, entangled with frequency-encoded optical qubits may be provided. This may provide the basic element of an interferometrically stable quantum network by enforcing, for example, a single transmission channel for robust, frequency-encoded photonic qubits.

Quantum mechanics may be used to permit secure information communication between remote locations. However, direct optical fiber based quantum communication over distances greater than about 100 km is challenging due to intrinsic fiber losses. To overcome this limitation, consistent with embodiments of the invention, quantum state storage may be used at intermediate locations on the transmission channel, where inter conversion of the information from light to matter to light may occur. The interface between photonic communication channels and storage elements may use a quantum repeater. There has been rapid progress in interfacing photonic and stored atomic qubits.

Consistent with embodiments of the invention, for example, interferometrically robust atomic and (near-infrared) photonic qubits and their entanglement for a quantum repeater based on co-trapped mixed species atomic ensembles and frequency photonic qubits may be provided. This may be used to stabilize two interferometrically separate paths used for qubit entanglement distribution. By employing an atomic cascade emission scheme, this opens the possibility to quantum telecommunication utilizing dual species atomic qubits and telecom wavelength frequency qubits as the basic building blocks.

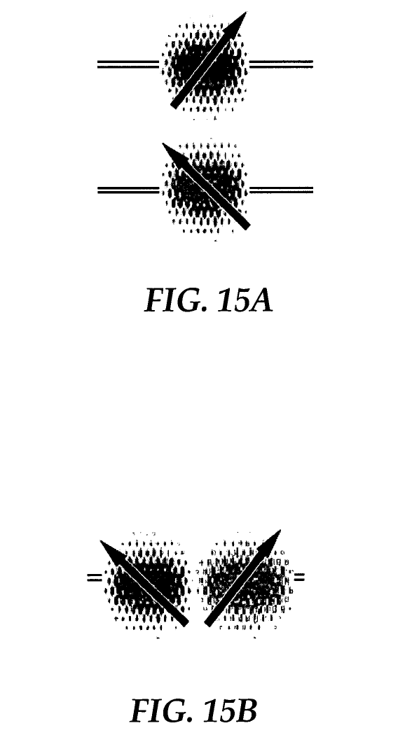

FIG. 15A shows two qubit states that may be encoded in spatially separated systems (ensembles) allowing for individual addressing of the two states. FIG. 15A shows an architecture consistent with embodiments of the invention to encode two qubit states into two distinct matter species.

Embodiments of the invention may use independent addressing of the two qubit basis states with frequency encoded photonic qubits transmitted over a single-mode fiber channel. The two basis states of a matter qubit may each be encoded as a single spin wave excitation of two different atomic species, either isotopes, or chemically distinct elements, co-trapped in the same region of space. The distinct nature of the two atomic species may imply spectroscopically resolved atomic transitions corresponding to the various light field frequencies involved in the manipulations. Therefore, it is possible to achieve independent generation and manipulation of entanglement of the two species while the transmission channels for entanglement distribution involve the very same spatial modes. This may remove the sensitivity to phase fluctuations on time-scales slower than the entanglement-length doubling scales. The encoding of an atomic qubit as excitations in two spatially separate atomic ensembles requires stabilization of the associated Mach-Zender interferometer defined by the optical paths through the ensembles. Consistent with embodiments of the invention, the equivalent task is to reduce the relative energy shifts of the ground states of the two co-trapped atomic species, something that is in any case essential to successfully read out an atomic excitation.

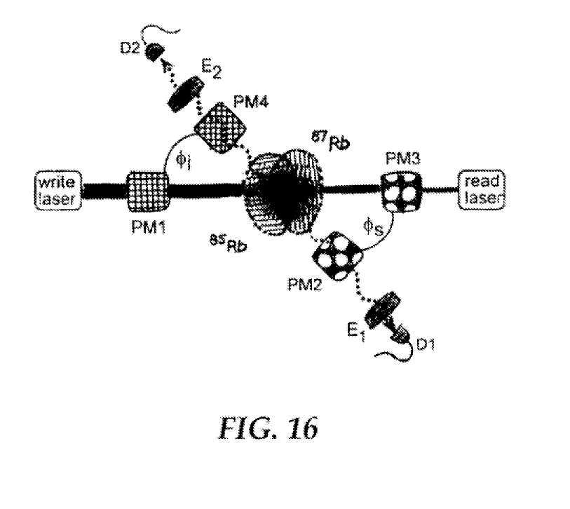

FIG. 16 shows a schematic showing the geometry of the addressing and scattered fields from the co-trapped isotope mixture of, for example, ⁸⁵Rb/⁸⁷Rb. The write and read laser fields generate signal and idler fields, respectively detected at D1 and D2; E1, E2 may be optical frequency filters.

A co-trapped isotope mixture of ⁸⁵Rb and ⁸⁷Rb, containing, respectively, N₈₅ and N₈₇ atoms cooled in a magneto optical trap, as shown in FIG. 16, may be considered. Unpolarized atoms of isotope I (I ε {85, 87}) may be prepared in the ground hyperfine level |a^{(I)} , where |a⁽⁸⁵⁾ ≡|5S_{1/2}, Fₐ⁽⁸⁵⁾=3 , |a⁽⁸⁷⁾ ≡|5S_{1/2}, Fₐ⁽⁸⁷⁾=2 , and F_{f}^{(I)} is the total atomic angular momentum for level |f^{(I)} . The Raman configuration may be considered with ground levels |a^{(I)} |b^{(I)} and excited level |c^{(I)} with energies h̅ωₐ^{(I)}, h̅ω_{b}^{(I)}, and h̅ω_{c}^{(I)} respectively. Level |b^{(I)} corresponds to the ground hyperfine level with smaller angular momentum, while level |c^{(I)} is the |5P_{1/2} hyperfine level with F_{c}^{(I)}=Fₐ^{(I)}. A 150 ns long write laser pulse of wave vector k_{w}=k_{w}ŷ, horizontal polarization _{H}=−z and temporal profile φ(t) (normalized to unity ∫ dt^{|φ(t)|}^{²}=1) impinges on an electrooptic modulator (EOM), producing sidebands with frequencies ck_{w}⁽⁸⁵⁾=ck_{w}−δω_{w} and ck_{w}⁽⁸⁷⁾=ck_{w}+δω_{w}(δω_{w}=531.5 MHz) nearly resonant on the respective isotopic D₁(|a^{(I)} ⇄|c^{(I)} ) transitions with detunings Δ_{I}=ck_{w}^{(I)}−(w_{c}^{(I)}−wₐ⁽ⁱ⁾)≈−10 MHz. Spontaneous Raman scattering of the write fields results in signal photons with frequencies ck₈^{(I)}=ck_{w}^{(I)}+(w_{b}^{(I)}−wₐ^{(I)}) on the |b^{(I)} ⇄|c^{(I)} transitions. The positive frequency component of the detected signal electric field from isotope I with vertical polarization eᵥ is given by:

$${\hat{E}}^{( ι ) ( + )} ( r , t ) = \sqrt{\frac{ℏ {k}_{s}^{( ι )}}{2 {ε}_{0}}} {e}^{- {ick}_{a}^{( ι )} ( t - {\hat{k}}_{a}^{( ι )} \cdot r )} \times {u}_{s} ( r ) {\hat{ψ}}_{s}^{( ι )} ( t - {\hat{k}}_{s} \cdot r ) {e}_{v} , \qquad ( 1 )$$

where uₛ (r) is the transverse spatial profile of the signal field (normalized to unity in its transverse plane), and ⁽⁾(t) is the annihilation operator for the signal field. These operators obey the usual free field, narrow bandwidth bosonic commutation relations [^_{B}^{(l)}(t), ^_{B}^{(l′)}(t′)]=δ_{,}δ(t−t′). The emission of H-polarized signal photons creates correlated atomic spin-wave excitations with annihilation operators given by:

$${\hat{s}}^{( l )} = cos {θ}_{l} {{\hat{s}}^{( l )}}_{- 1} + sin {θ}_{l} {\hat{s}}^{( l )} + 1 , \\ where \\ {cos}^{2} {θ}_{ι} = {\sum }_{m = - {F}_{a}^{( ι )}}^{{F}_{a}^{( ι )}} {X}_{m , - 1}^{( ι ) 2} / {\sum }_{α = \pm 1} {\sum }_{m = - {F}_{a}^{( ι )}}^{{F}_{a}^{( ι )}} {X}_{m , α}^{( ι ) 2} , \\ {X}_{m , α}^{( ι )} ≡ {C}_{m 0 m}^{{F}_{a}^{( ι )} 1 {F}_{c}^{( ι )}} {C}_{m - α α m}^{{F}_{b}^{( ι )} 1 {F}_{c}^{( ι )}} \qquad ( 2 )$$

is a product of Clebsch-Gordon coefficients, and the spherical vector components of the spin wave are given by

$${\hat{s}}_{α}^{( ι )} = {\sum }_{m = - {F}_{a}^{( ι )}}^{{F}_{a}^{( ι )}} \frac{{X}_{m , α}^{( ι )}}{\sqrt{{\sum }_{m = - {F}_{a}^{( ι )}}^{{F}_{a}^{( ι )}} {\vert {X}_{m , α}^{( ι )} \vert}^{2}}} {\hat{s}}_{m , α}^{( ι )} . \qquad ( 3 )$$

The spin wave Zeeman components of isotope I are given in terms of the μ-th ^{I}Rb atom transition operators σₐ⁽ⁱ⁾,m;b^{(I)}, m′ and the write u_{w} (r) and signal uₛ (r) field spatial profiles

$${\hat{s}}_{m , α}^{( ι )} = \frac{i {\overline{A}}^{( ι )}}{\sqrt{{p}^{( ι )} {N}_{ι}}} {\sum }_{μ}^{{N}_{ι}} {\tilde{σ}}_{{a}^{( ι )} , m ; {b}^{( ι )} , m}^{μ} \times {e}^{i ( {k}_{s}^{( ι )} - {k}_{w}^{( ι )} ) \cdot {r}_{μ}} {u}_{s} ( {r}_{μ} ) {u}_{w}^{*} ( {r}_{μ} ) . \qquad ( 4 )$$

The effective overlap of the write beam and the detected signal mode [14] is given by

$${\overline{A}}^{( ι )} = {( \int {d}^{3} r {\vert {u}_{s} ( r ) {u}_{w}^{*} ( r ) \vert}^{2} \frac{{n}^{( ι )} ( r )}{{N}_{ι}} )}^{- 1 / 2} . \qquad ( 5 )$$

The interaction responsible for scattering into the collected signal mode is given by

$${\hat{H}}_{s} ( t ) = i ℏχϕ ( t ) ( cos η {\hat{ψ}}_{s}^{( 85 ) †} ( t ) {\hat{s}}^{( 85 ) †} + sin η {\hat{ψ}}_{s}^{( 87 ) †} ( t ) {\hat{s}}^{( 87 ) †} ) + h . c . , \qquad ( 6 )$$

Where χ≡\sqrt{χ₈₅²+χ₈₇²} is a dimensionless interaction parameter,

$${χ}_{ι} ≡ \frac{\sqrt{2} {d}_{cb}^{( ι )} {d}_{ca}^{( ι )}}{{\overline{A}}^{( ι )} {Δ}_{ι}} \frac{{k}_{s}^{( ι )} {k}_{w}^{( ι )} {n}_{w}^{( ι )} {N}_{ι}}{( 2 {F}_{a}^{( ι )} + 1 ) {ℏε}_{0}} \sqrt{{\sum }_{α = \pm 1} {\sum }_{m = - {F}_{a}^{( ι )}}^{{F}_{a}^{( ι )}} {\vert {X}_{m , α}^{( ι )} \vert}^{2}} , \qquad ( 7 )$$

d_{ca}^{(ι)} and d_{cb}^{(ι)} are reduced matrix elements, n_{ω}^{(ι)} is the average number of photons in the write pulse sideband with frequency ck_{w}^{(l)}, and the parametric mixing angle η is given by cos² η=χ₈₅²/(χ₈₆²+χ₈₇²). The interaction picture Hamiltonian also includes terms representing Rayleigh scattering and Raman scattering into undetected modes. One can show, however, that these terms commute with the signal Hamiltonian (Eq. (6)) and with the operators ^ₛ^{(ι)}(t) and ŝ^{(I)} to order O(I/^{\sqrt{N}}). As a result, the interaction picture density operator for the signal-spin wave system (tracing over undetected field modes) is given by Û_{\hat{ρ}}_{₀}Û^{†} where \hat{ρ}₀ is the initial density matrix of the unpolarized ensemble and the vacuum electromagnetic field, and the unitary operator Û is given by

ln Û=χ(cos η\hat{α}^{(85)†}ŝ^{(85)†}+sin η\hat{α}^{(87)†}ŝ^{(87)†}−h.c.), (8)

where \hat{α}^{(ι)}=∫dtφ*(t)^ₛ^{(ι)}(t) is the discrete signal mode bosonic operator. When the write pulse is sufficiently weak we may write Û−1=χ(cos η\hat{α}^{(85)†}ŝ^{(85)†}+sin η\hat{α}^{(87)†}ŝ^{(87)†})+O(χ²), i.e., the Raman scattering produces entanglement between a two-mode field (frequency qubit) and the isotopic spin wave (dual species matter qubit). Although we explicitly treat isotopically distinct species, it is clear that the analysis is easily generalized to chemically distinct atoms and/or molecules.

To characterize the nonclassical correlations of this system, the signal field is sent to an electro-optic phase modulator (PM2 in FIG. 16) driven at a frequency δω₈=δω_{w}−[(ωₐ⁽⁸⁷⁾−ω_{b}⁽⁸⁷⁾)−(ωₐ⁽⁸⁵⁾−ω_{b}⁽⁸⁵⁾)]/2=1368 MHz. The modulator combines the two signal frequency components into a central frequency ck₈=c(k₈⁽⁸⁵⁾+kₛ⁽⁸⁷⁾)/2 with a relative phase φₛ. A photoelectric detector preceded by a filter (an optical cavity, E1 in FIG. 2) which reflects all but the central signal frequency is used to measure the statistics of the signal. The detected signal field may be described using the bosonic field operator,

$${\hat{ψ}}_{s} ( t , {φ}_{s} ) = \sqrt{\frac{{ε}_{s}^{( 85 )}}{2}} {e}^{- i {φ}_{s} / 2} {\hat{ψ}}_{s}^{( 85 )} ( t ) + \sqrt{\frac{{ε}_{s}^{( 87 )}}{2}} {e}^{i {φ}_{s} / 2} {\hat{ψ}}_{s}^{( 87 )} ( t ) + \sqrt{\frac{1 - {ε}_{s}^{( 85 )}}{2}} {e}^{- i {φ}_{s} / 2} {\hat{ξ}}_{s}^{( 85 )} ( t ) + \sqrt{\frac{1 - {ε}_{s}^{( 87 )}}{2}} {e}^{i {φ}_{s} / 2} {\hat{ξ}}_{s}^{( 87 )} ( t ) \qquad ( 9 )$$

where εₛ^{(ι)} ε[0,1] is the signal detection efficiency including detection and propagation losses as well as losses to other frequency sidebands within PM2, and \hat{ξ}₈^{(ι)}(t, φₛ) represents undetected modes. The spin wave qubit is retrieved by shining a vertically polarized read pulse into a third electro-optic phase modulator (PM3 in FIG. 16), producing two sidebands with frequencies ckᵣ⁽⁸⁵⁾ and ckᵣ⁽⁸⁷⁾ resonant on the |b⁽⁸⁵⁾ ⇄|c⁽⁸⁵⁾ and |b⁽⁸⁷⁾ |c⁽⁸⁷⁾ transitions respectively. This results in the transfer of the spin wave excitations to horizontally polarized idler photons emitted in the phase matched directions kᵢ^{(I)}=k_{w}^{(I)}−kₛ^{(I)}+kᵣ^{(I)}. We treat the retrieval dynamics using the effective beam splitter relations \hat{b}^{(ι)}=\sqrt{εᵣ^{(ι)}}ŝ^{(ι)}+\sqrt{1−εᵣ^{(ι)}}ζᵣ^{(ι)}, where εᵣ^{(I)} is the retrieval efficiency of the spin wave stored in the isotope ¹Rb, \hat{b}^{(ι)}=∫dtφᵢ^{(ι)}*(t)^ᵢ^{(ι)}(t) is the discrete idler bosonic operator for an idler photon of frequency ckᵢ^{(ι)}, φᵢ^{(ι)}(t) is the temporal profile of an idler photon emitted from the ^{I}Rb spin wave (normalized to unity ), and ^ᵢ^{(ι)}(t) is the annihilation operator for an idler photon emitted at time t. As with the signal operators, the idler field operators obey the usual free field, narrow bandwidth bosonic commutation relations [^ᵢ^{(ι)}(t), ^ᵢ^{ι′)†}(t′)]=δ_{ι,ι′}δ(t−t′). A fourth EOM, PM4, driven at a frequency δωᵢ=δω_{w}−(Δ₈₅+Δ₈₇)/2=531.5 MHz combines the idler frequency components into a sideband with frequency ckᵢ=c(kᵢ⁽⁸⁵⁾+kᵢ⁽⁸⁷⁾)/2 with a relative phase φi. The combined idler field is measured by a photon counter preceded by a frequency filter (an optical cavity, E2 in FIG. 2) which only transmits fields of the central frequency ckᵢ. The detected idler field is described by the bosonic field operator,

$${\hat{ψ}}_{i} ( t , {φ}_{i} ) = \sqrt{\frac{{ε}_{i}^{( 85 )}}{2}} {e}^{i {φ}_{i} / 2} {\hat{ψ}}_{i}^{( 85 )} ( t ) + \sqrt{\frac{{ε}_{i}^{( 87 )}}{2}} {e}^{- i {φ}_{i} / 2} {\hat{ψ}}_{i}^{( 87 )} ( t ) + \sqrt{\frac{1 - {ε}_{i}^{( 85 )}}{2}} {e}^{- i {φ}_{i} / 2} {\hat{ξ}}_{i}^{( 85 )} ( t ) + \sqrt{\frac{1 - {ε}_{i}^{( 87 )}}{2}} {e}^{- i {φ}_{i} / 2} {\hat{ξ}}_{i}^{( 87 )} ( t ) \qquad ( 10 )$$

where εᵢ^{(ι)} ε [0,1] is the idler detection efficiency including detection and propagation losses as well as losses to other frequency sidebands within PM4, and \hat{ξ}ᵢ(t, φᵢ) accounts for undetected modes.

The signal-idler correlations result in high visibility fringes in the coincidence rates Cₛᵢ(φₛ,φᵢ)=∫dtₛ∫dt ᵢ ^ₛ^{†}(tₛ, φₛ)^ᵢ^{†}(tᵢ, φᵢ)^ᵢ(tᵢ, φᵢ)^ₛ(tₛ, φₛ) . From the state of the atom-signal system after the write process, Û_{\hat{ρ}}_{₀}Û^{†}, (Eq.8), we calculate the coincidence rates to second order in χ,

$${C}_{si} ( {φ}_{s} , {φ}_{i} ) = \frac{{χ}^{2}}{4} ( {μ}^{( 85 )} {cos}^{2} η + {μ}^{( 87 )} {sin}^{2} η + \sqrt{{μ}^{( 85 )} {μ}^{( 87 )}} sin 2 η cos ( {φ}_{i} - {φ}_{s} + {φ}_{0} ) ) \qquad ( 11 )$$

where μ^{(ι)}≡εᵣ^{(ι)}εᵢ^{(ι)}εₛ^{(ι)}, and and φ₀ represent a real amplitude and phase, respectively, such that

e^{-iφo}=e^{-(δφ}^{ₛ}^{²}^{+δφ}^{_{ι}}^{²}^{)/2}∫dtφᵢ⁽⁸⁵⁾*(t)φᵢ⁽⁸⁷⁾(t) (12)

and classical phase noise in the rf driving of the EOM pairs PM1,4 and PM2,3, may be accounted for by treating φₛ and φᵢ as Gaussian random variables with variances δφ²ₛ and δφ²ᵢ respectively, (FIG. 16.) When the write fields are detuned such that the rates of correlated signal-idler coincidences are equal (i.e., when μ⁽⁸⁵⁾ cos² η=μ⁽⁸⁷⁾ sin² η), the fringe visibility is maximized, and Eq. (11) reduces to

$${C}_{si} ( {φ}_{s} , {φ}_{i} ) = \frac{{χ}^{2}}{2} {μ}^{( 85 )} {cos}^{2} η [ 1 + cos ( {φ}_{i} - {φ}_{s} + {φ}_{0} ) ] . \qquad ( 13 )$$

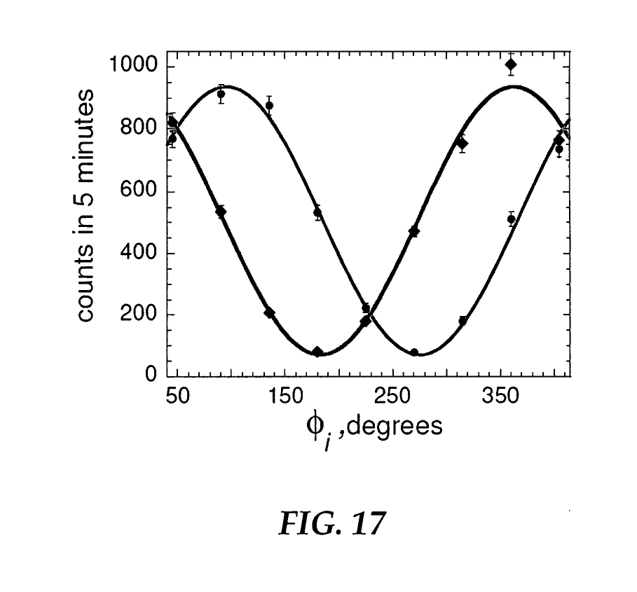

FIG. 17 shows measured Cₛᵢ(φₛ,φᵢ) as a function of φᵢ; diamonds, φₛ=0, circlesme, φₛ=−π/2 (φ₀ is chosen to be zero). Solid lines are sinusoidal fringes based on Eq. (13) with =0.86. Single channel counts of D1 and D2 show no dependence on the phases. FIG. 17 shows coincidence fringes as a function of φᵢ taken for two different values of φₛ. The correlation function may be E(φₛ,φᵢ), given by

$$\frac{{C}_{si} ( {φ}_{s} , {φ}_{i} ) - {C}_{si} ( {φ}_{s} , {φ}_{i}^{⊥} ) - {C}_{si} ( {φ}_{s}^{⊥} , {φ}_{i} ) + {C}_{si} ( {φ}_{s}^{⊥} , {φ}_{i}^{⊥} )}{{C}_{si} ( {φ}_{s} , {φ}_{i} ) + {C}_{si} ( {φ}_{s} , {φ}_{i}^{⊥} ) + {C}_{si} ( {φ}_{s}^{⊥} , {φ}_{i} ) + {C}_{si} ( {φ}_{s}^{⊥} , {φ}_{i}^{⊥} )} , \qquad ( 14 )$$

where φ_{s[i]}^{⊥}=φ_{s[i]}+π. By analogy with polarization correlations, the detected signal [idler] field ^_{8[i]}(t, φ_{s[i]}^{⊥}) is orthogonal to ^_{s[i]}(t, φ_{s[i]}), i.e., [^_{s[i]}(t, φ_{s[i]}), \hat{φ}_{s[i]}^{†}(t′, φ_{s[i]}^{†})]=0. A classical local hidden variable theory yields the Bell inequality |S|≦2, where S≡E(φₛ, φᵢ)−E(φ′ₐ, φᵢ)−E(φₐ, φ′ᵢ)−E(φ′ₛ, φ′ᵢ) [16]. Using Eq.(13), the correlation function is given by

E(φₛ, φᵢ)= cos(φₐ−φᵢ+φ₀). (15)

Choosing, e.g., the angles φₛ=−φ₀, φᵢ=π/4, φ′ₛ=−φ₀−π/2, and φ′ᵢ=3π/3, we find the Bell parameter S=2\sqrt{2} .

TABLE 2

| φₛ | φᵢ | E(φₛ, φᵢ) |
|---|---|---|
| 0 | π/4 | 0.629 ± 0.018 |
| 0 | 3π/4 | −0.591 ± 0.018 |
| −π/2 | π/4 | −0.614 ± 0.018 |
| −π/2 | 3π/4 | −0.608 ± 0.018 |
| | | S = 2.44 ± 0.036 |

Table 2 shows a measured correlation function E(θₛ,θᵢ) and S for Δt=150 ns delay between write and read pulses; all the errors are based on the statistics of the photon counting events. Table 2 presents measured values for the correlation function E(φₛ,φᵢ) using the canonical set of angles φₛ,φᵢ. I may be found that S=2.44±0.036 2−a violation of the Bell inequality. The value of S is smaller than the ideal value of 2.83, consistent with the measured value of =0.86. Temporal mismatch of the idler fields wavepackets as a result of propagation through optically thick isotopic mixture is a possible cause for the reduction of visibility, while the effects of rf phase noise may be negligible.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A quantum communications repeater comprising:
means for producing an entangled pair of photons comprising a first photon configured for long-distance quantum communications and a second photon configured for mapping into a storage element;
means for mapping the second photon into the storage element; and
means for transmitting a signal corresponding to the first photon over an optical fiber.

2. The quantum communications repeater of claim 1, wherein the means for producing comprising a first pump and a second pump cascaded together to produce the entangled pair of photons.

3. The quantum communications repeater of claim 2, wherein the first pump and the second pump are cascaded together wherein the first photon is emitted on an upper arm and the second photon is emitted to an atomic ground state.

4. The quantum communications repeater of claim 1, wherein the storage element comprises a single atom.

5. The quantum communications repeater of claim 1, wherein the storage element comprises an atomic ensemble.

6. The quantum communications repeater of claim 5, wherein the atomic ensemble a volume comprising,
a first isotope vapor configured to store a first state of a first qubit, and
a second isotope vapor configured to store a second state of the first qubit.

7. The quantum communications repeater of claim 1, wherein the first photon is in a wavelength range from 1.1 μm to 1.6 μm.

8. The quantum communications repeater of claim 1, wherein the second photon is in a wavelength range from 600 nm to 900 nm.

9. The quantum communications repeater of claim 1, further comprising:
means for providing a deterministic single photon; and
means for providing error correction using the deterministic single photon.

10. A method for providing a deterministic single photon, the method comprising:
determining that an excitation is present in an atomic ensemble;
hitting, when it is determined that the excitation is present in the atomic ensemble, the atomic ensemble with a first laser; and
collecting the single photon in response to hitting the atomic ensemble with the first laser.

11. The method of claim 10, wherein determining that the excitation is present in the atomic ensemble comprises:
hitting the atomic ensemble a plurality of times with a second laser; and
determining that the excitation is present in the atomic ensemble when hitting the atomic ensemble the plurality of times with the second laser produces a photon.

12. The method of claim 10, further comprising using the single photon for error correction.

13. The method of claim 10, further comprising using the single photon for error correction in a quantum communications repeater.

14. A system for providing a deterministic single photon, the system comprising:
means for determining that an excitation is present in an atomic ensemble;
means for hitting, when it is determined that the excitation is present in the atomic ensemble, the atomic ensemble with a first laser; and
means for collecting the single photon in response to hitting the atomic ensemble with the first laser.

15. The system of claim 14, wherein determining that the excitation is present in the atomic ensemble comprises:
means for hitting the atomic ensemble a plurality of times with a second laser; and
means for determining that the excitation is present in the atomic ensemble when hitting the atomic ensemble the plurality of times with the second laser produces a photon.

16. The system of claim 14, further comprising means for using the single photon for error correction.

17. The system of claim 14, further comprising means for using the single photon for error correction in a quantum communications repeater.

18. A multiplexed quantum repeater network comprising:
terminal nodes;
a plurality of internal nodes each comprising a pair of quantum memory sites wherein all quantum memory sites comprise a plurality of independent memory elements; and
means for sequentially scanning all of the quantum memory sites within at least one of the internal nodes to connect any available memory elements within a scanned memory site.

19. A storage element comprising:
an atomic ensemble having a volume, the volume comprising,
a first isotope vapor configured to store a first state of a first qubit, and
a second isotope vapor configured to store a second state of the first qubit.

20. The storage element of claim 19, wherein the first state of the first qubit stored in the first isotope vapor and the second state of the first qubit stored in the second isotope vapor are entangled with a frequency encoded optical qubit.
